(19) United States
(12) Patent Application Publication
(10) Pub. No.: US 2008/0003422 A1
(43) Pub. Date: Jan. 3, 2008

(54) Polymer Compound, Polymer Thin Film and Polymer Thin Film Device Using the Same

(75) Inventor: Masato Ueda, Tsukuba-shi (JP)

Correspondence Address: SUGHRUE MION, PLLC, 2100 PENNSYLVANIA AVENUE, N.W., SUITE 800, WASHINGTON, DC, 20037, US

(73) Assignee: Sumitomo Chemical Company, Limited, Tokyo (JP)

(21) Appl. No.: 11/572,513

(22) PCT Filed: Jul. 27, 2005
(86) PCT No.: PCT/JP05/14156

§ 371 Date: Jan. 23, 2007

(51) Int. Cl. B32B 27/28; B05D 3/12; C08G 63/68; C08G 69/26; C08G 73/00; C08G 75/00; C08G 77/04

(52) U.S. Cl. 428/220; 427/240; 528/26; 528/27; 528/28; 528/332; 528/364; 528/380; 528/391; 528/397; 528/398; 528/405; 528/422; 528/423

(57) ABSTRACT

A polymer compound comprising a repeating unit of the following formula (1) and a repeating unit of the following formula (2) and having a polystyrene-reduced number-average molecular weight of 10³ to 10⁸: 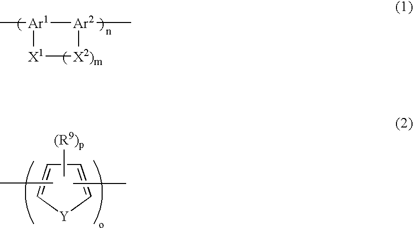
(wherein, Ar¹ and Ar² represent each independently a tri-valent aromatic hydrocarbon group or a tri-valent heterocyclic group, X¹ and X² represent each independently O, S, C(═O), S(═O), SO₂ or the like, and X¹ and X² are not identical. Y represents O, S, and R⁹ represents a halogen atom, alkyl group, alkyloxy group or the like. m represents 0 or 1, and n represents an integer from 1 to 6. o represents an integer from 1 to 6, and p represents an integer from 0 to 2.).

### TECHNICAL FIELD

The present invention relates to a polymer compound, a polymer thin film containing the polymer compound, and a polymer thin film device using the polymer thin film.

### BACKGROUND ART

Thin films containing an organic material having electron transportability or hole transportability are expected to be applied to thin film devices such as organic thin film transistors, organic solar batteries and the like and variously investigated.

As materials to be used for such thin films, there are known polyphenylenevinylene derivatives, polyfluorene derivatives, polyphenylene derivatives, polythiophene derivatives, polythienylenevinylene derivatives and the like that are polymer compounds having an electron transportable or hole transportable molecular structure in the main chain (Appl. Phys. Lett. Vol. 49 (1986), p. 1210; Appl. Phys. Lett. Vol. 63 (1993), p. 1372; Appl. Phys. Lett. Vol. 77 (2000), p. 406; “Semiconducting Polymers”, Eds. G. Hadziioannou and P. F. van Hutten (2000) Wiley-VCH).

### DISCLOSURE OF THE INVENTION

The present invention has an object of providing a novel polymer compound which is useful as a material of a thin film for polymer thin film devices such as organic thin film transistors, organic solar batteries and the like.

That is, the present invention provides a polymer compound containing a repeating unit of the following formula (1) and a repeating unit of the following formula (2) and having a polystyrene-reduced number-average molecular weight of 10³ to 10⁸: 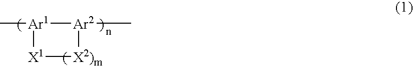
(wherein, Ar¹ and Ar² represent each independently a tri-valent aromatic hydrocarbon group or a tri-valent heterocyclic group, X¹ and X² represent each independently O, S, C(═O), S(═O), SO₂, C(R¹)(R²), Si(R³)(R⁴), N(R⁵), B(R⁶), P(R⁷) or P(═O)(R⁸), R¹ to R⁸ represent each independently a hydrogen atom, halogen atom, alkyl group, alkyloxy group, alkylthio group, aryl group, aryloxy group, arylthio group, arylalkyl group, arylalkyloxy group, arylalkylthio group, acyl group, acyloxy group, amide group, acid imide group, imine residue, amino group, substituted amino group, substituted silyl group, substituted silyloxy group, substituted silylthio group, substituted silylamino group, mono-valent heterocyclic group, heteroaryloxy group, heteroarylthio group, arylalkenyl group, arylethynyl group, carboxyl group, alkyloxycarbonyl group, aryloxycarbonyl group, arylalkyloxycarbonyl group, heteroaryloxycarbonyl group or cyano group. Here, X¹ and X² are not identical. R¹ and R² in C(R¹)(R²) and R³ and R⁴ in Si(R³)(R⁴) may mutually be connected to form a ring. m represents 0 or 1, and n represents an integer from 1 to 6. When m=0, X¹ does not represent C(R¹)(R²). X¹ and Ar² are connected to adjacent carbon atoms among carbon atoms constituting the aromatic ring of Ar¹ (hereinafter, referred to as adjacent positions of the aromatic ring, in some cases), and when m=1, X² and Ar¹ are connected to adjacent positions of the aromatic ring of Ar², when m=0, X¹ and Ar¹ are connected to adjacent positions of the aromatic ring of Ar².), 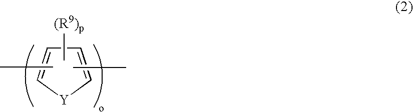
(wherein, o represents an integer from 1 to 10, p represents an integer from 0 to 2, Y represents O, S, C(R¹⁰)(R¹¹), Si(R¹²)(R¹³) or N(R¹⁴), and R¹⁰, R¹¹, R¹², R¹³ and R¹⁴ represent each independently a hydrogen atom, halogen atom, alkyl group, alkyloxy group, alkylthio group, aryl group, aryloxy group, arylthio group, arylalkyl group, arylalkyloxy group, arylalkylthio group, acyl group, acyloxy group, amide group, acid imide group, imine residue, amino group, substituted amino group, substituted silyl group, substituted silyloxy group, substituted silylthio group, substituted silylamino group, mono-valent heterocyclic group, heteroaryloxy group, heteroarylthio group, arylalkenyl group, arylethynyl group, carboxyl group, alkyloxycarbonyl group, aryloxycarbonyl group, arylalkyloxycarbonyl group, heteroaryloxycarbonyl group or cyano group. Here, R¹⁰ and R¹¹, and R¹² and R¹³ may mutually be connected to form a ring. R⁹ represents a halogen atom, alkyl group, alkyloxy group, alkylthio group, aryl group, aryloxy group, arylthio group, arylalkyl group, arylalkyloxy group, arylalkylthio group, acyl group, acyloxy group, amide group, acid imide group, imine residue, amino group, substituted amino group, substituted silyl group, substituted silyloxy group, substituted silylthio group, substituted silylamino group, mono-valent heterocyclic group, heteroaryloxy group, heteroarylthio group, arylalkenyl group, arylethynyl group, carboxyl group, alkyloxycarbonyl group, aryloxycarbonyl group, arylalkyloxycarbonyl group, heteroaryloxycarbonyl group or cyano group. When a plurality of R⁹s are present, they may be the same or different, and R⁹s may be mutually connected to form a ring.).

Further, the present invention provides a polymer compound, containing a repeating unit of the above-described formula (1), a repeating unit of the above-described formula (2) and a repeating unit of the following formula (3) and having a polystyrene-reduced number-average molecular weight of 10³ to 10⁸: 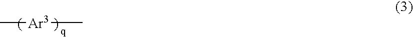
(wherein, Ar³ represents a di-valent aromatic hydrocarbon group, a di-valent heterocyclic group or —CR¹⁵═CR¹⁶—. R¹⁵ and R¹⁶ represent each independently a hydrogen atom, halogen atom, alkyl group, alkyloxy group, alkylthio group, aryl group, aryloxy group, arylthio group, arylalkyl group, arylalkyloxy group, arylalkylthio group, acyl group, acyloxy group, amide group, acid imide group, imine residue, amino group, substituted amino group, substituted silyl group, substituted silyloxy group, substituted silylthio group, substituted silylamino group, mono-valent heterocyclic group, heteroaryloxy group, heteroarylthio group, arylalkenyl group, arylethynyl group, carboxyl group, alkyloxycarbonyl group, aryloxycarbonyl group, arylalkyloxycarbonyl group, heteroaryloxycarbonyl group or cyano group. q represents an integer from 1 to 6.).

### BRIEF EXPLANATION OF DRAWINGS

FIG. 1 is a schematic sectional view of a stagger type organic thin film transistor according to the present invention.

FIG. 2 is a schematic sectional view of a stagger type top-and-bottom contact organic thin film transistor according to the present invention.

FIG. 3 is a schematic sectional view of an inverse stagger type organic thin film transistor according to the present invention.

FIG. 4 is a schematic sectional view of an inverse stagger type top-and-bottom contact organic thin film transistor according to the present invention.

FIG. 5 is a schematic sectional view of a solar battery according to the present invention.

FIG. 6 is a schematic sectional view of a laminated type optical sensor according to the present invention.

FIG. 7 is a schematic sectional view of a laminated type optical sensor according to the present invention.

FIG. 8 is a schematic sectional view of a mono-layer type optical sensor according to the present invention.

FIG. 9 is a schematic sectional view of a mono-layer type electrophotographic photoreceptor according to the present invention.

FIG. 10 is a schematic sectional view of a laminated type electrophotographic photoreceptor according to the present invention.

FIG. 11 is a schematic sectional view of a laminated type electrophotographic photoreceptor according to the present invention.

FIG. 12 is a schematic sectional view of a spatial light modulator according to the present invention.

### DESCRIPTION OF MARKS

1. substrate

2. polymer thin film

3. insulation film

4. gate electrode

5. source electrode

6. drain electrode

7. electrode

8. charge generating layer

9. liquid crystal layer

10. dielectric mirror layer

### BEST MODES FOR CARRYING OUT THE INVENTION

The polymer compound of the present invention contains a repeating unit of the above-described formula (1) and a repeating unit of the above-described formula (2). Further, the polymer compound of the present invention contains a repeating unit of the above-described formula (1), a repeating unit of the above-described formula (2) and a repeating unit of the above-described formula (3).

In the above-described formula (1), Ar¹ and Ar² represent each independently a tri-valent aromatic hydrocarbon group or a tri-valent heterocyclic group.

Here, the tri-valent aromatic hydrocarbon group means an atom group remaining after removing three hydrogen atoms from a benzene ring or condensed ring, and has usually 6 to 60, preferably 6 to 20 carbon atoms, and groups described below are exemplified. Of them, most preferable are atom groups remaining after removing three hydrogen atoms from a benzene ring. The aromatic hydrocarbon group may have thereon a substituent. The carbon number of the tri-valent aromatic hydrocarbon group does not include the carbon number of a substituent.

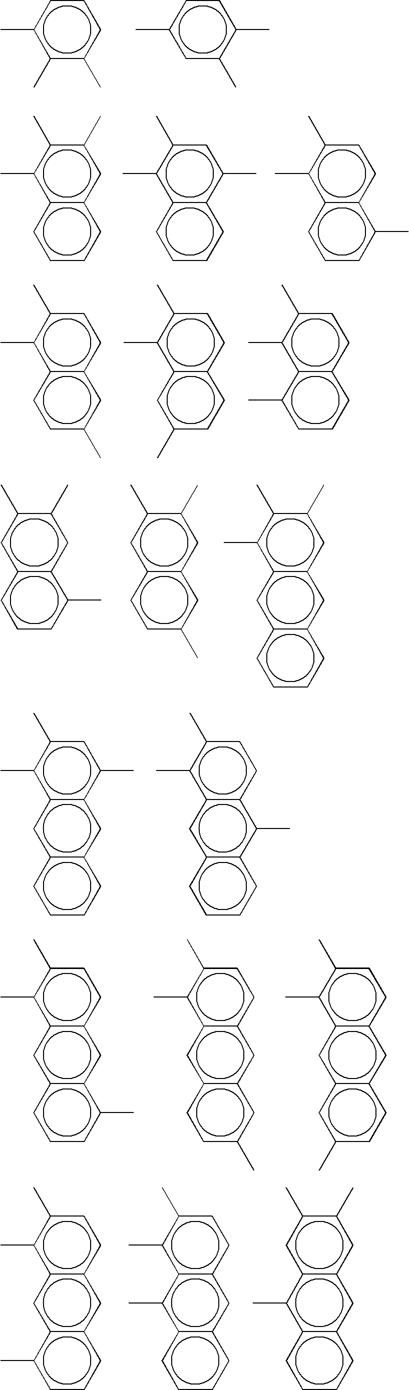

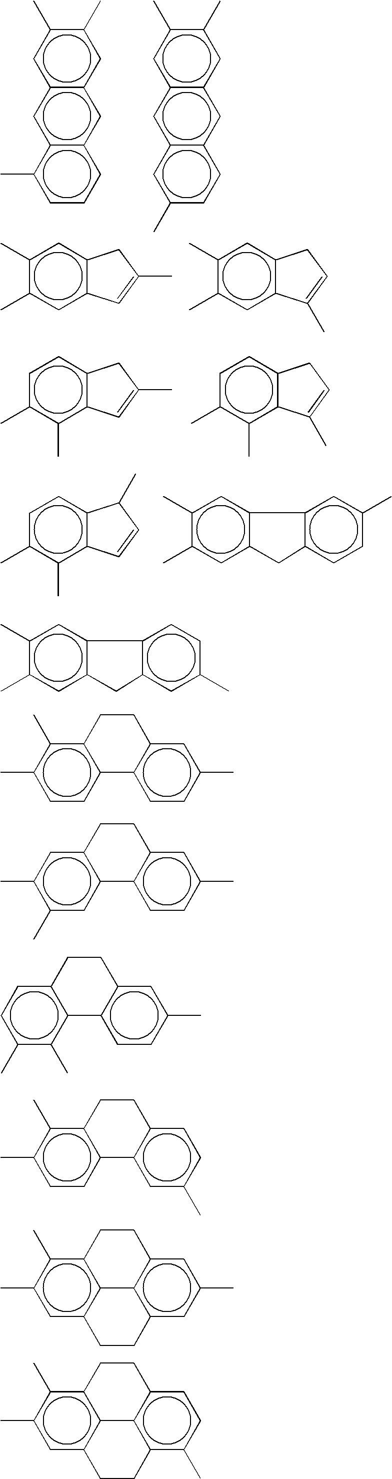

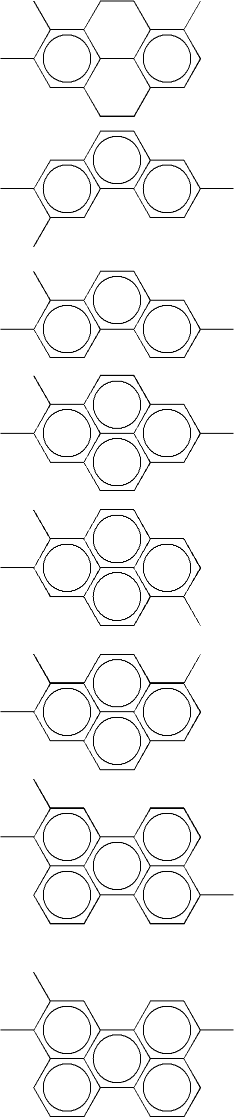

The tri-valent heterocyclic group means an atom group remaining after removing three hydrogen atoms from a heterocyclic compound, and has usually 4 to 60, preferably 4 to 20 carbon atoms. The heterocyclic group may have thereon a substituent, and the carbon number of the heterocyclic group does not include the carbon number of a substituent.

Here, the heterocyclic compound includes organic compounds having a cyclic structure in which devices constituting the ring include not only a carbon atom but also hetero atoms such as oxygen, sulfur, nitrogen, phosphorus, boron, silicon and the like in the ring.

As the tri-valent heterocyclic group, for example, the following groups are exemplified.

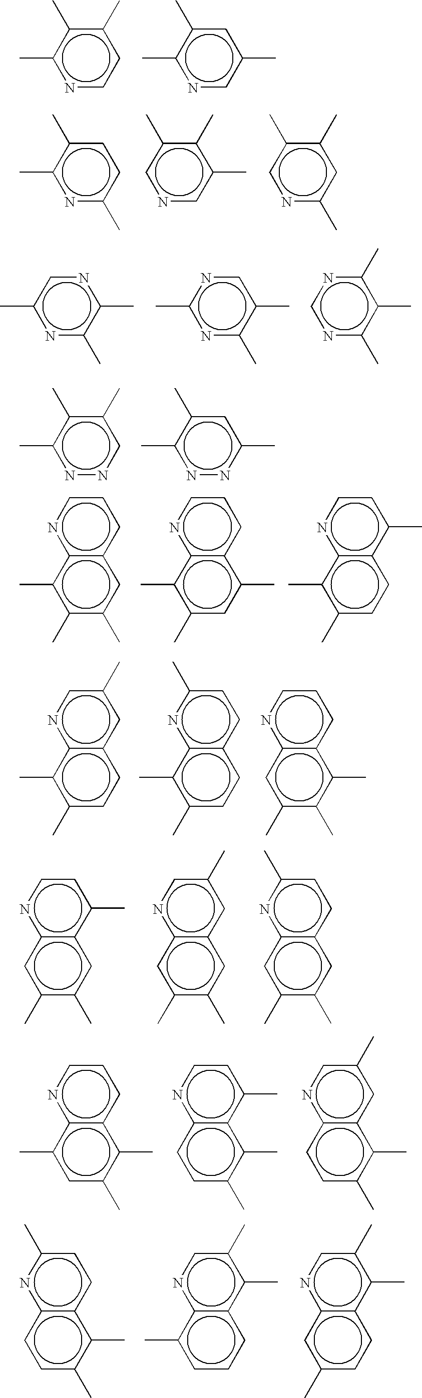

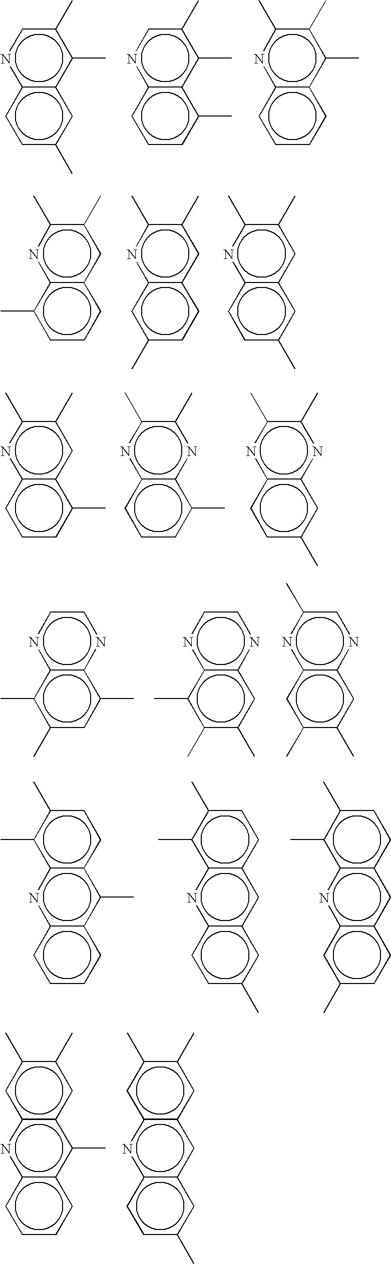

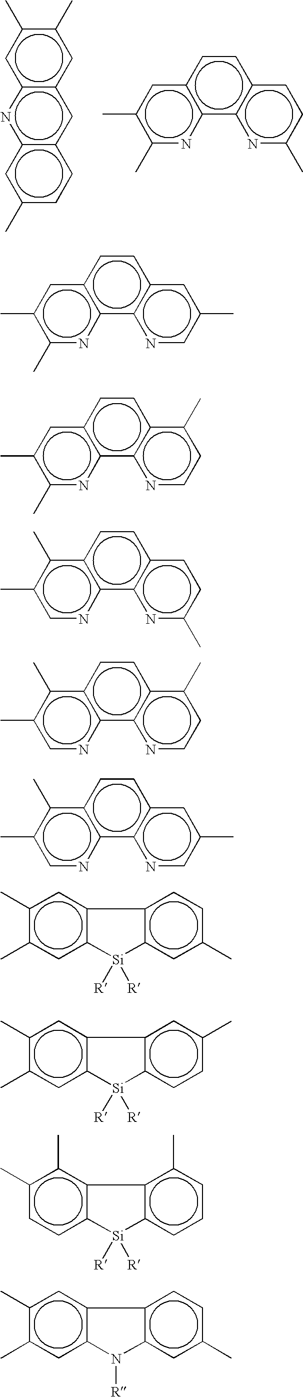

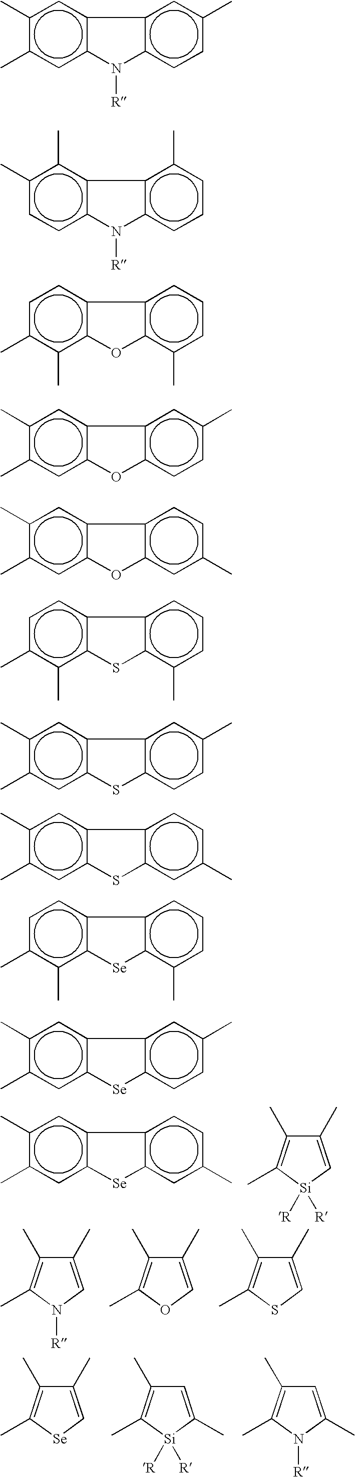

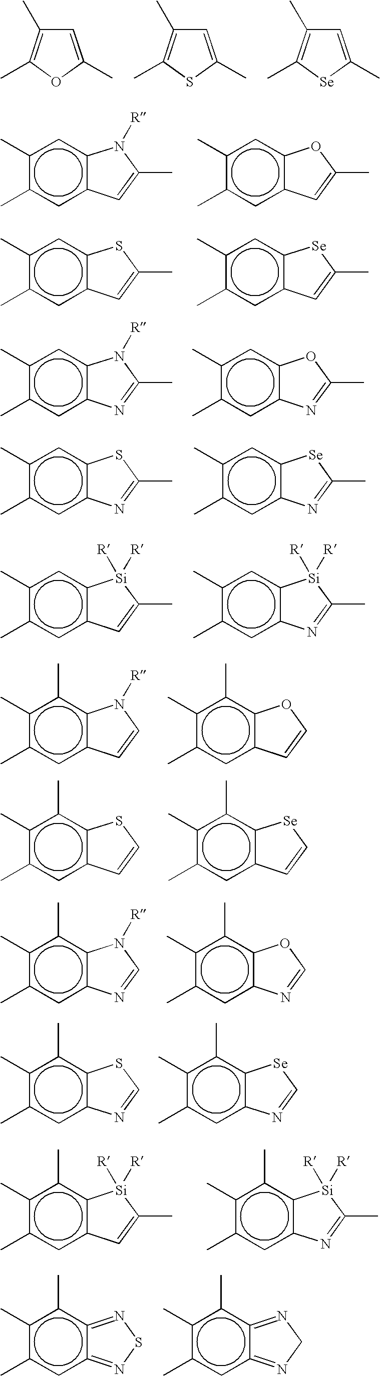

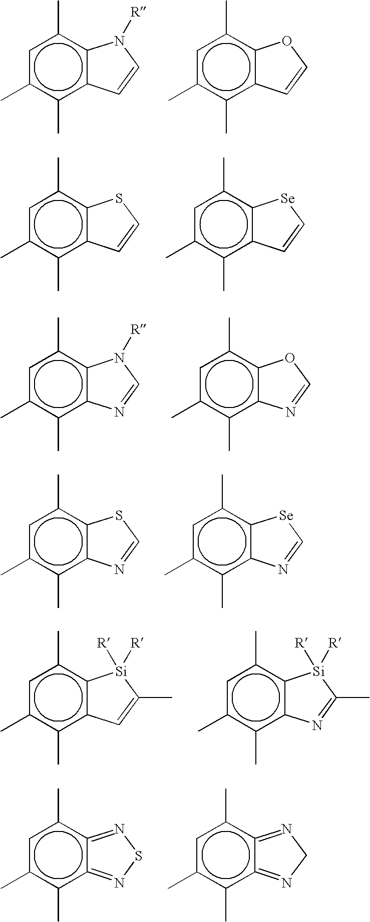

In the above-described formulae, R's represent each independently a hydrogen atom, halogen atom, alkyl group, alkoxy group, alkylthio group, alkylamino group, aryl group, aryloxy group, arylthio group, arylamino group, arylalkyl group, arylalkyloxy group, arylalkylthio group, arylalkylamino group, acyloxy group, amide group, arylalkenyl group, arylalkynyl group, mono-valent heterocyclic group or cyano group.

R″ represents a hydrogen atom, alkyl group, aryl group, arylalkyl group, substituted silyl group, acyl group, mono-valent heterocyclic group, heteroaryloxy group or heteroarylthio group.

As the substituent optionally carried on the tri-valent aromatic hydrocarbon group or tri-valent heterocyclic group, exemplified are halogen atoms, alkyl groups, alkyloxy group, alkylthio groups, aryl groups, aryloxy groups, arylthio groups, arylalkyl groups, arylalkyloxy groups, arylalkylthio groups, acyl groups, acyloxy groups, amide groups, acid imide groups, imine residues, amino groups, substituted amino groups, substituted silyl groups, substituted silyloxy groups, substituted silylthio groups, substituted silylamino groups, mono-valent heterocyclic groups, heteroaryloxy groups, heteroarylthio groups, arylalkenyl groups, arylethynyl groups, carboxyl group, alkyloxycarbonyl groups, aryloxycarbonyl groups, arylalkyloxycarbonyl groups, heteroaryloxycarbonyl groups or cyano groups. When there are a plurality of substituents, the substituents may mutually form a ring.

In the above-described formula (1), X¹ and X² represent each independently O, S, C(═O), S(═O), SO₂, C(R¹)(R²), Si(R³)(R⁴), N(R⁵), B(R⁶), P(R⁷) or P(═O)(R⁸). Here, X¹ and X² are not identical.

In the formula (1), R¹ to R⁸ represent each independently a hydrogen atom, halogen atom, alkyl group, alkyloxy group, alkylthio group, aryl group, aryloxy group, arylthio group, arylalkyl group, arylalkyloxy group, arylalkylthio group, acyl group, acyloxy group, amide group, acid imide group, imine residue, amino group, substituted amino group, substituted silyl group, substituted silyloxy group, substituted silylthio group, substituted silylamino group, mono-valent heterocyclic group, heteroaryloxy group, heteroarylthio group, arylalkenyl group, arylethynyl group, carboxyl group, alkyloxycarbonyl group, aryloxycarbonyl group, arylalkyloxycarbonyl group, heteroaryloxycarbonyl group or cyano group.

R¹ and R² in C(R¹)(R²) and R³ and R⁴ in Si(R³)(R⁴) may mutually be connected to form a ring. In this case, exemplified as the ring structure part are specifically the following parts.

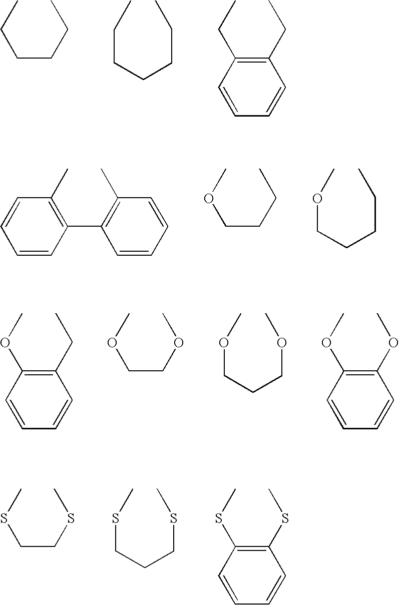

When m=0, X¹ does not represent C(R¹)(R²).

In the above-described formula (1), n represents an integer from 1 to 6, and integers of 1 to 3 are more preferable and integers of 1 to 2 are further preferable.

In the above-described formula (1), m represents 0 or 1, and in the case of materials for organic thin film transistors, it is preferable that m is 1 and it is particularly preferable that n is 1 and m is 1.

Among others, X² in the formula (1) is preferably C(R¹)(R²), Si(R³)(R⁴), N(R⁵), B(R⁶), P(R⁷) or P(═O)(R⁸), and more preferably C(R¹)(R²) (wherein, R¹ to R⁸ represent each independently the same meanings as described above).

Further, X¹ in the formula (1) is preferably O, S, C(═O), S(O), SO₂, Si(R³)(R⁴), N(R⁵), B(R⁶), P(R⁷) or P(═O)(R⁸), more preferably O, S, C(═O), S(O) or SO₂, and particularly preferably O or S.

When m=1, mentioned as —X¹—X²— are the following groups (4), (5) and (6).

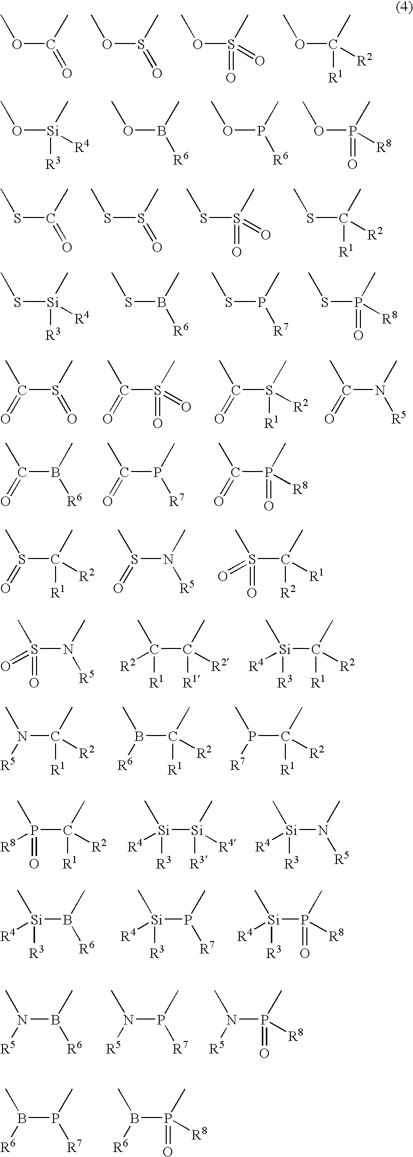

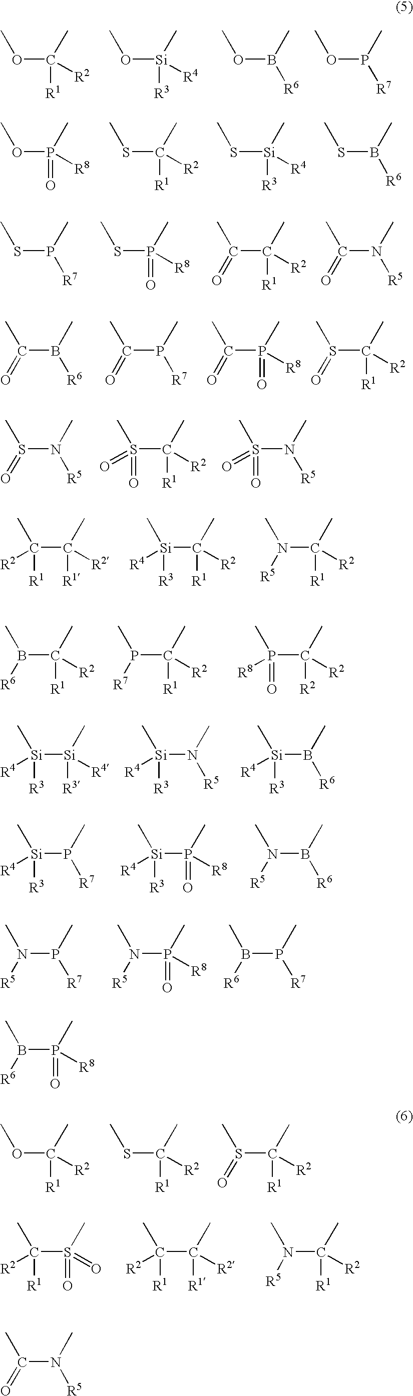

Among others, groups (5) and (6) are preferable and groups (6) are more preferable from the standpoint of the stability of the compound.

The polymer compound of the present invention contains a repeating unit of the formula (2) in addition to a repeating unit of the above-described formula (1).

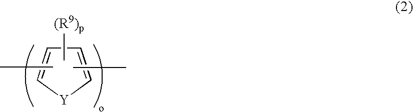

In the formula (2), o represents an integer from 1 to 10, and integers of 1 to 6 are more preferable and integers of 1 to 5 are further preferable.

In the above-described formula (2), p represents an integer from 0 to 2. When o is 2 or less, it is preferable that p is 0 or 1, and it is further preferable that p is 0. When o is 3 or more, it is preferable that p=1 or 2 in one or more of a plurality of 5-membered rings from the standpoint of solubility.

In the above-described formula (2), Y represents O, S, C(R¹⁰)(R¹¹), Si(R¹²)(R¹³) or N(R¹⁴), and O and S are preferable, and S is more preferable.

R¹⁰ to R¹⁴ represent each independently a hydrogen atom, halogen atom, alkyl group, alkyloxy group, alkylthio group, aryl group, aryloxy group, arylthio group, arylalkyl group, arylalkyloxy group, arylalkylthio group, acyl group, acyloxy group, amide group, acid imide group, imine residue, amino group, substituted amino group, substituted silyl group, substituted silyloxy group, substituted silylthio group, substituted silylamino group, mono-valent heterocyclic group, heteroaryloxy group, heteroarylthio group, arylalkenyl group, arylethynyl group, carboxyl group, alkyloxycarbonyl group, aryloxycarbonyl group, arylalkyloxycarbonyl group, heteroaryloxycarbonyl group or cyano group.

In the above-described formula (2), R⁹ represents a halogen atom, alkyl group, alkyloxy group, alkylthio group, aryl group, aryloxy group, arylthio group, arylalkyl group, arylalkyloxy group, arylalkylthio group, acyl group, acyloxy group, amide group, acid imide group, imine residue, amino group, substituted amino group, substituted silyl group, substituted silyloxy group, substituted silylthio group, substituted silylamino group, mono-valent heterocyclic group, heteroaryloxy group, heteroarylthio group, arylalkenyl group, arylethynyl group, carboxyl group, alkyloxycarbonyl group, aryloxycarbonyl group, arylalkyloxycarbonyl group, heteroaryloxycarbonyl group or cyano group, preferably a halogen atom, alkyl group, alkyloxy group, alkylthio group, aryl group, aryloxy group, arylthio group, arylalkyl group, arylalkyloxy group or arylalkylthio group, and more preferably an alkyl group or alkyloxy group, and when there are a plurality of R⁹s, they may be the same or different, and R⁹s may be mutually connected to form a ring.

In the case of mutual connection of R⁹s to form a ring, exemplified as the ring structure part are specifically the following parts.

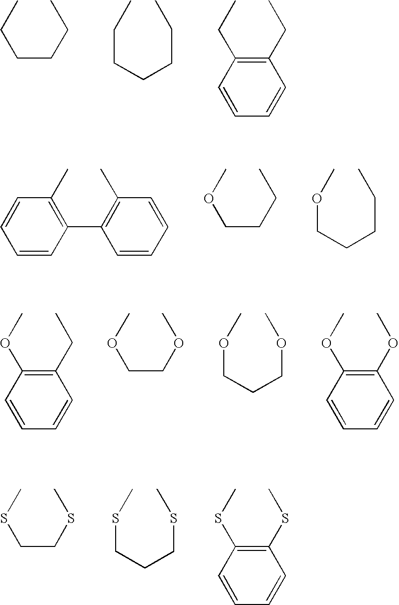

The polymer compound of the present invention may contain a repeating unit of the formula (3) in addition to a repeating unit of the above-described formula (1) and a repeating unit of the above-described formula (2).

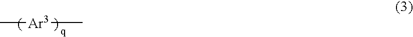

In the formula (3), Ar³ represents a di-valent aromatic hydrocarbon group, a di-valent heterocyclic group or —CR¹⁵═CR¹⁶—, preferably a di-valent heterocyclic group or —CR¹⁵═CR¹⁶— and more preferably —CR¹⁵═CR¹⁶—.

Here, the di-valent aromatic hydrocarbon group means an atom group remaining after removing two hydrogen atoms from a benzene ring or condensed ring, and has usually 6 to 60, preferably 6 to 20 carbon atoms, and exemplified are groups obtained by adding one hydrogen atom to any of portions from which three hydrogen atoms have been removed in the above-exemplified tri-valent aromatic hydrocarbon groups. Of them, most preferable are atom groups remaining after removing two hydrogen atoms from a benzene ring. The aromatic hydrocarbon group may have thereon a substituent. The carbon number of the di-valent aromatic hydrocarbon group does not include the carbon number of a substituent.

The di-valent heterocyclic group means an atom group remaining after removing two hydrogen atoms from a heterocyclic compound, and has usually 4 to 60, preferably 4 to 20 carbon atoms. As the di-valent heterocyclic group, exemplified are groups obtained by adding one hydrogen atom to any of portions from which three hydrogen atoms have been removed in the above-exemplified tri-valent aromatic hydrocarbon groups. The heterocyclic group may have thereon a substituent, and the carbon number of the heterocyclic group does not include the carbon number of a substituent.

In the above-described formula (3), R¹⁵ and R¹⁶ represent each independently a hydrogen atom, halogen atom, alkyl group, alkyloxy group, alkylthio group, aryl group, aryloxy group, arylthio group, arylalkyl group, arylalkyloxy group, arylalkylthio group, acyl group, acyloxy group, amide group, acid imide group, imine residue, amino group, substituted amino group, substituted silyl group, substituted silyloxy group, substituted silylthio group, substituted silylamino group, mono-valent heterocyclic group, heteroaryloxy group, heteroarylthio group, arylalkenyl group, arylethynyl group, carboxyl group, alkyloxycarbonyl group, aryloxycarbonyl group, arylalkyloxycarbonyl group, heteroaryloxycarbonyl group or cyano group.

In the formula (3), q represents an integer from 1 to 6, and integers of 1 to 3 are more preferable and integers of 1 to 2 are further preferable.

Among the polymer compounds of the present invention, preferable are those having a structure (7) obtained by connecting the formula (1) and the formula (2) from the standpoint of enhancing electron transportability or hole transportability.

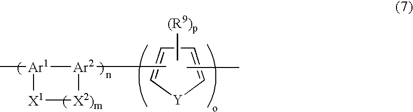

When the polymer compounds of the present invention contain a repeating unit of the above-described (3) in addition to a repeating unit of the above-described (1) and a repeating unit of the above-described (2), a plurality of repeating units of the formula (2) may be contained. When a plurality of repeating units of the formula (2) are contained, they may be the same or different. Preferable are those having a structure (8) obtained by connecting the formula (1), the formula (2) and the formula (3) from the standpoint of enhancing electron transportability or hole transportability.

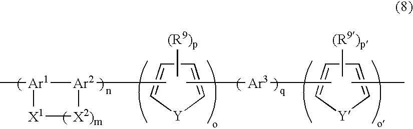

Here, Y′, R⁹′, o′ and p′ represent the same meanings as for the above-described Y, R⁹, o and p, and may be the same as or different from Y, R⁹, o and p.

As examples of the structure of the above-described formula (7), there are exemplified structures of the following formulae (9) to (14) and structures having further a substituent on an aromatic hydrocarbon or heterocyclic group in these structures when, for example, n=1; o=2, 3 or 5; Y═S. As examples of the structure of the above-described formula (8), there are exemplified structures of the following formulae (15) to (17) and structures having further a substituent on an aromatic hydrocarbon group or heterocyclic group in these structures when, for example, n=1; o=1; o′=1; q=1; Y═S; Y′═S. 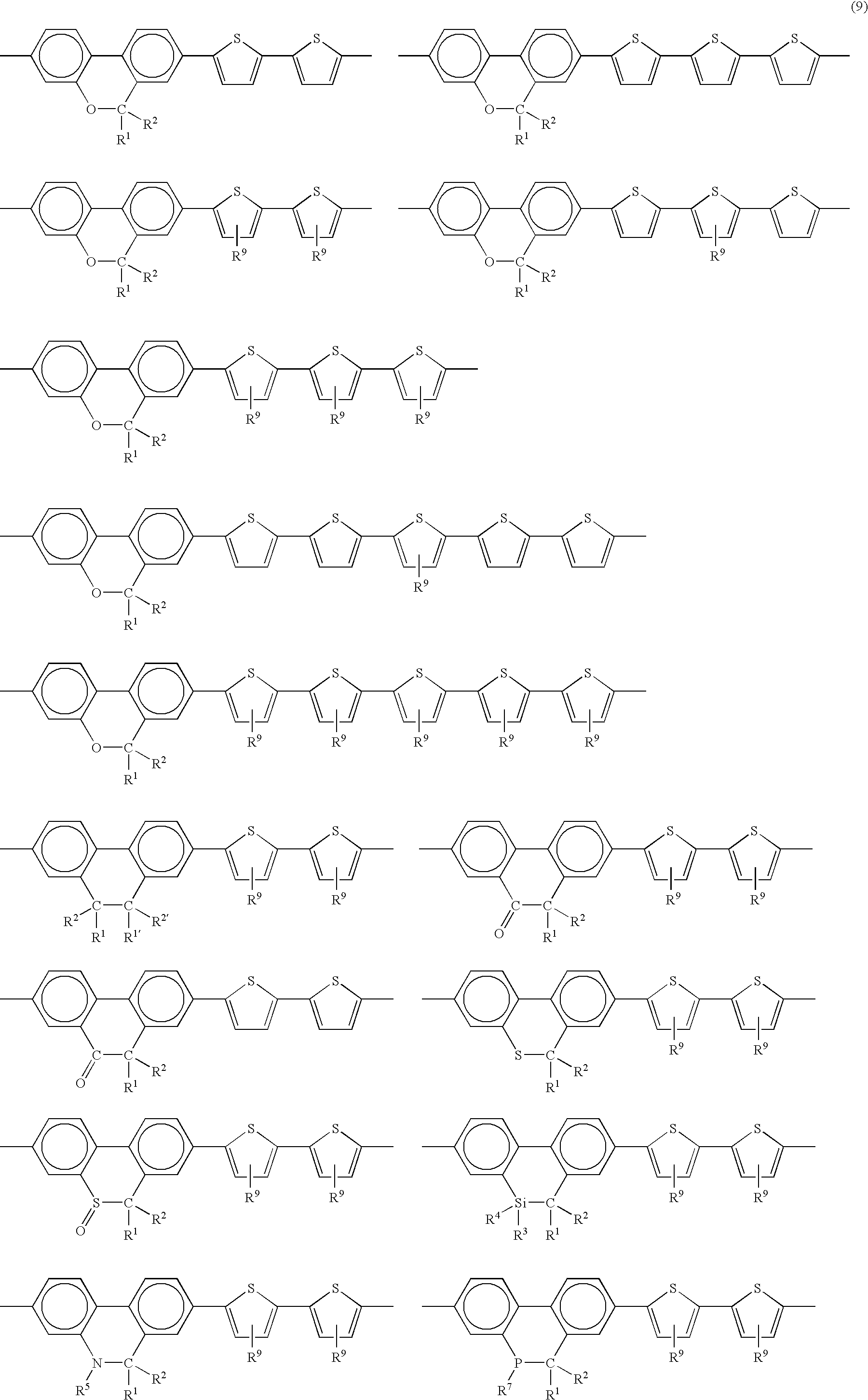 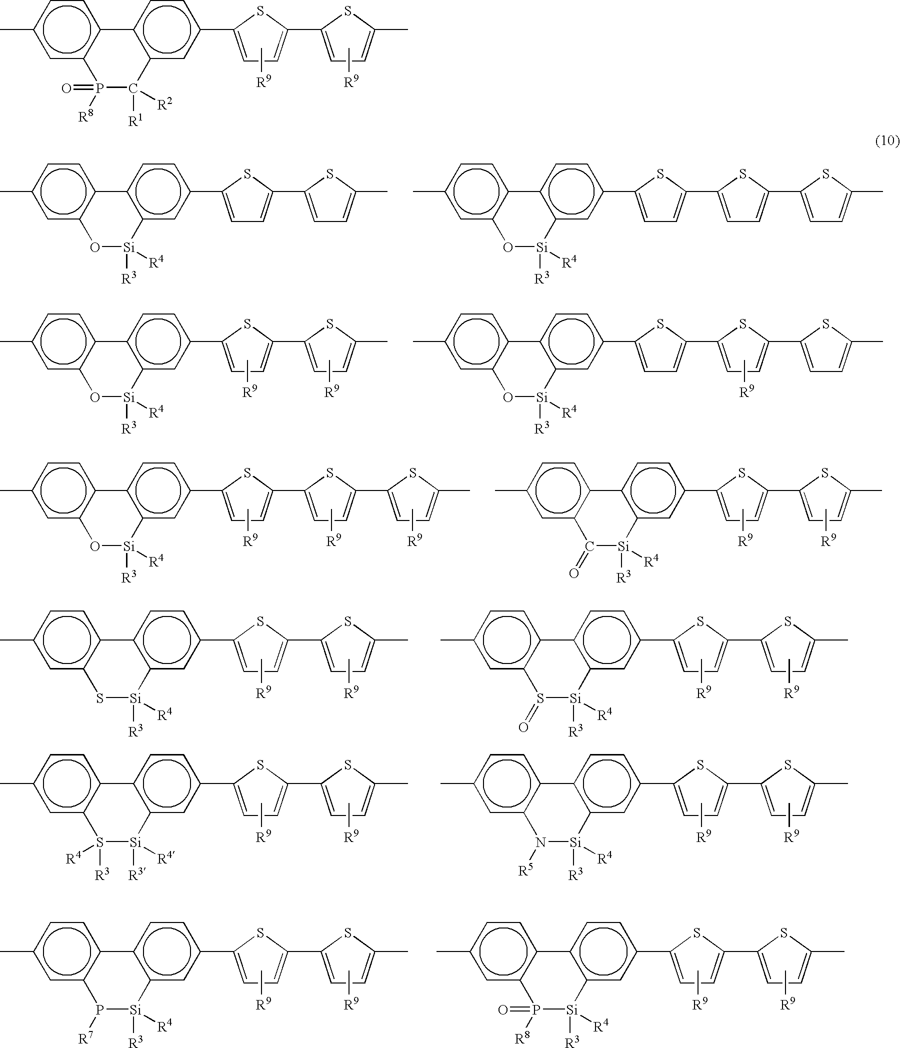 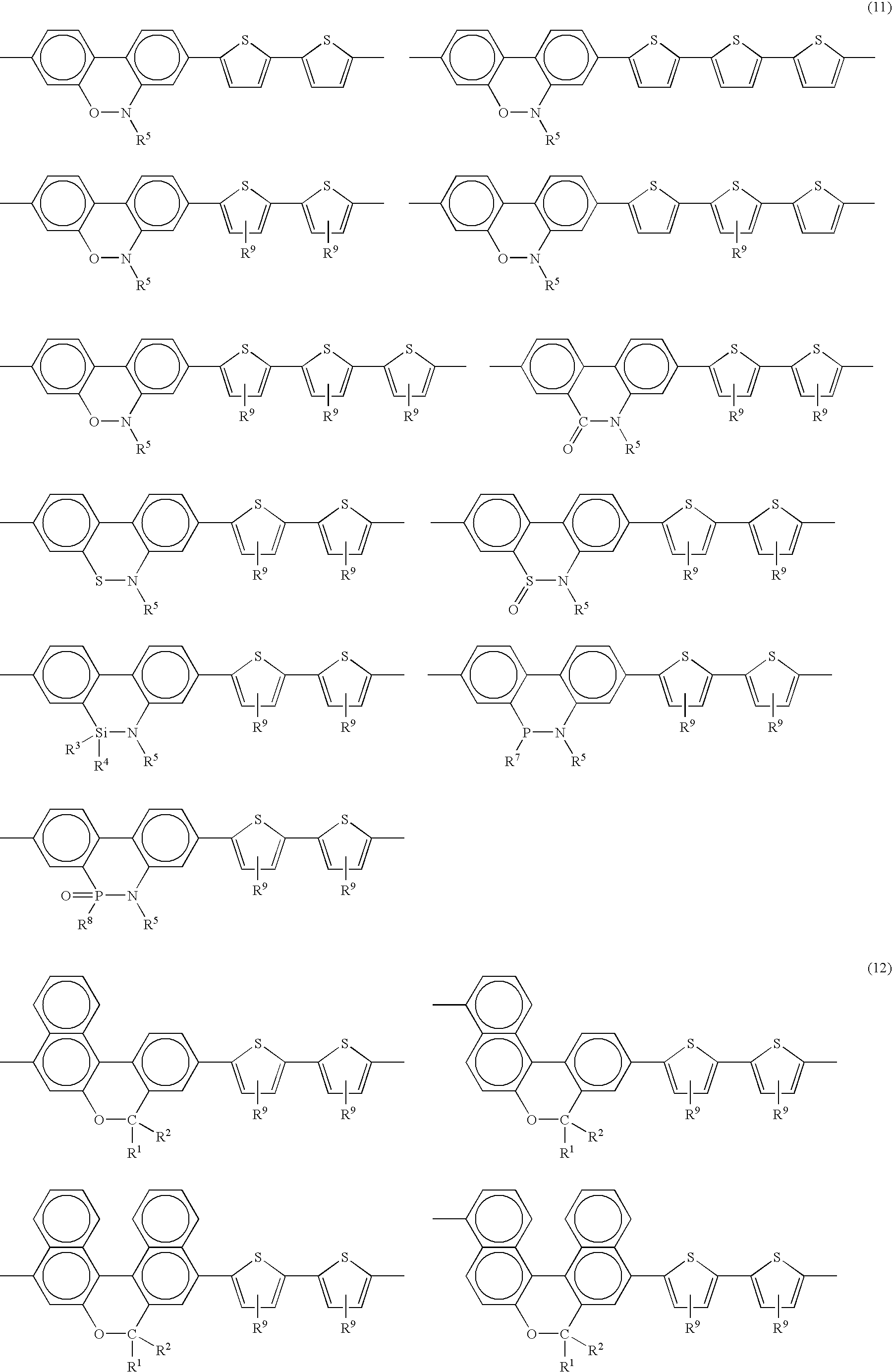 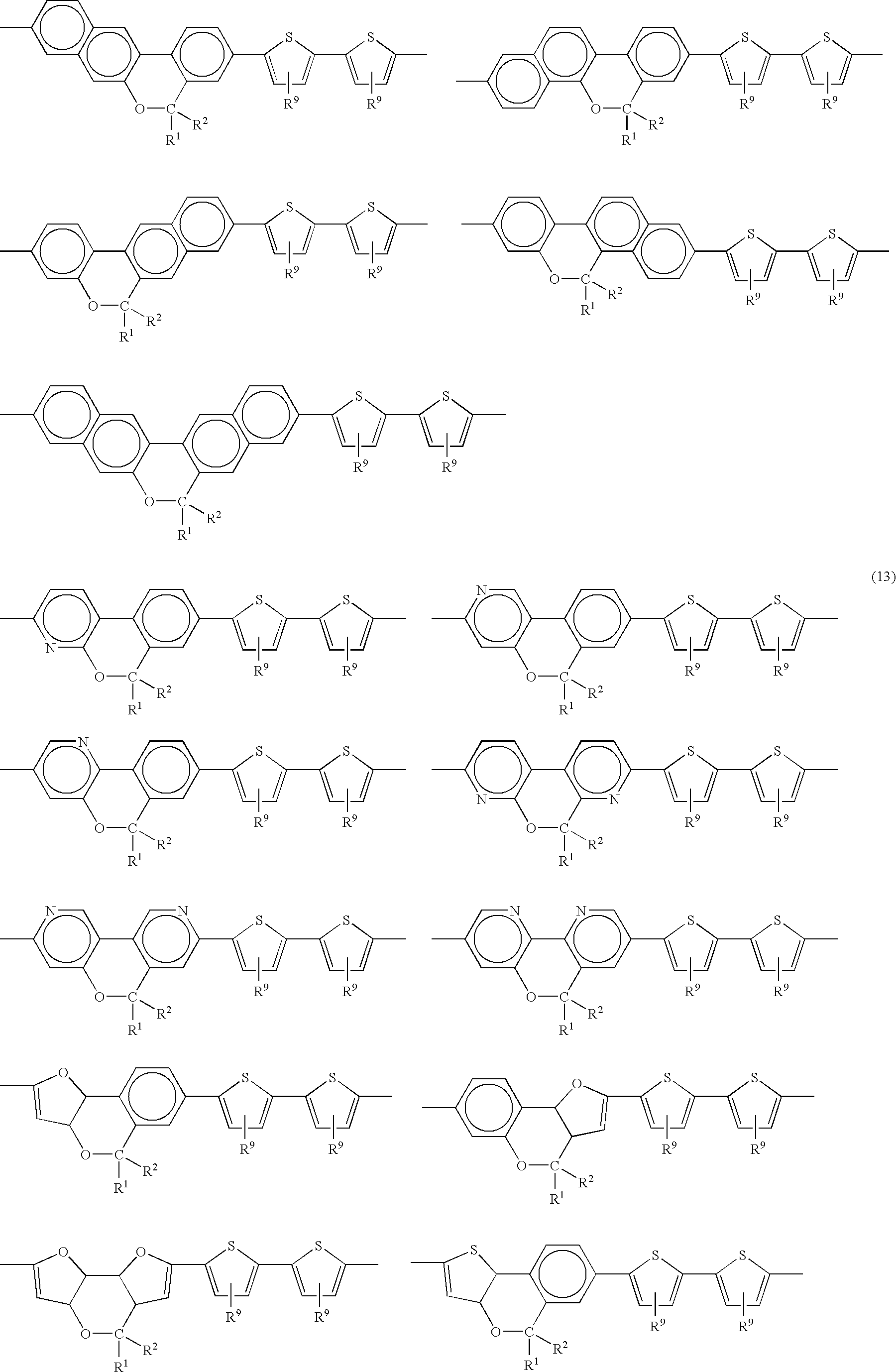 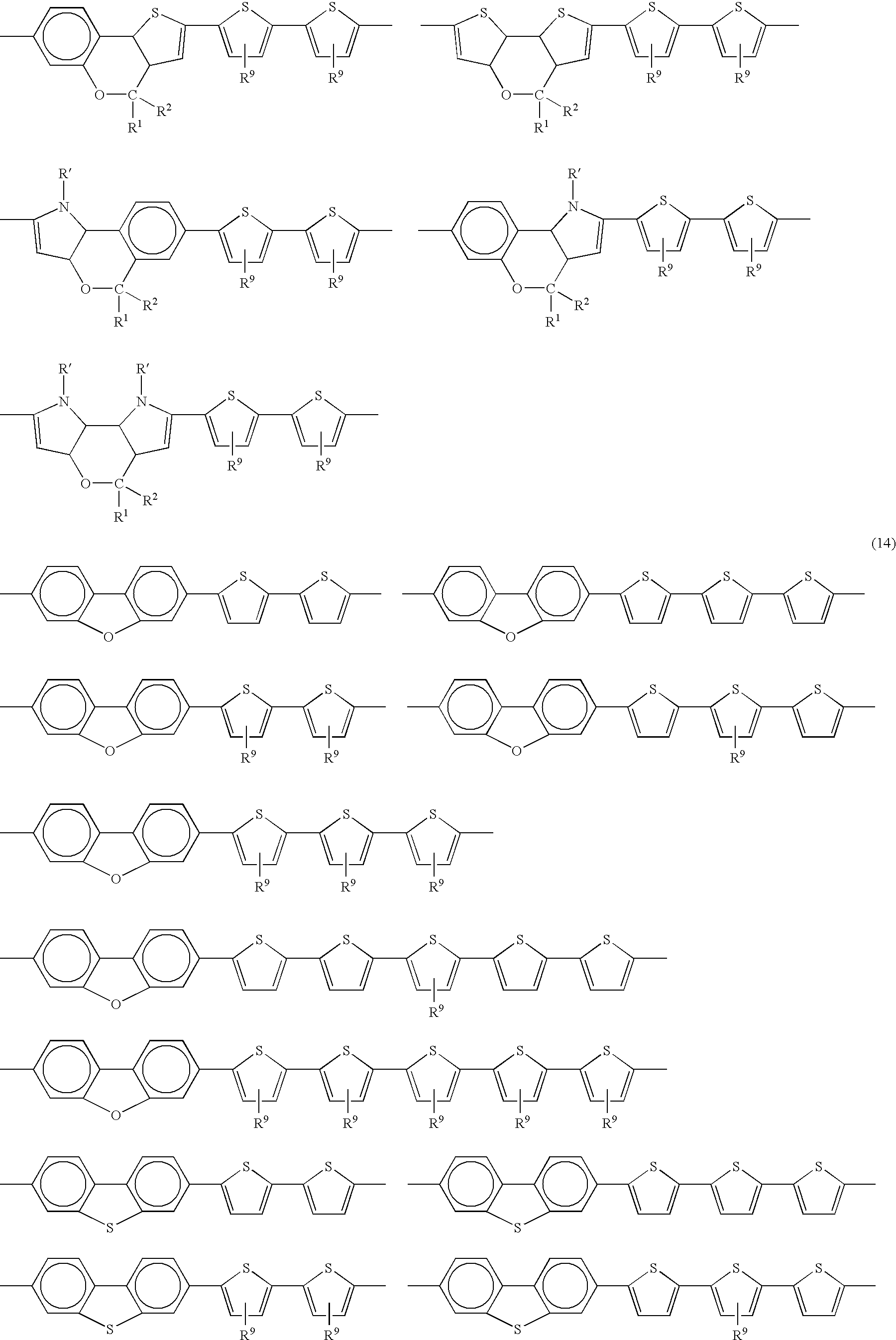 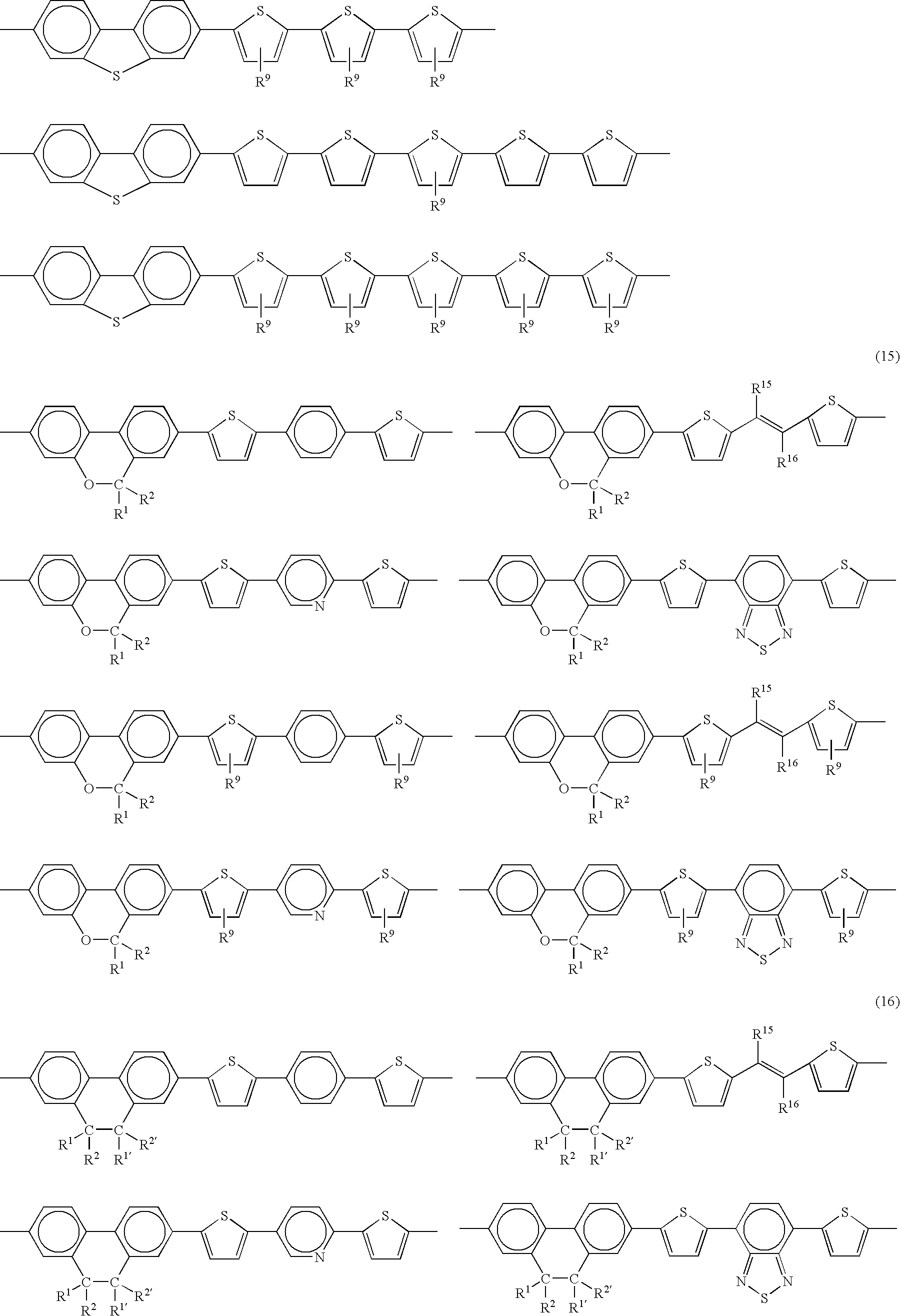 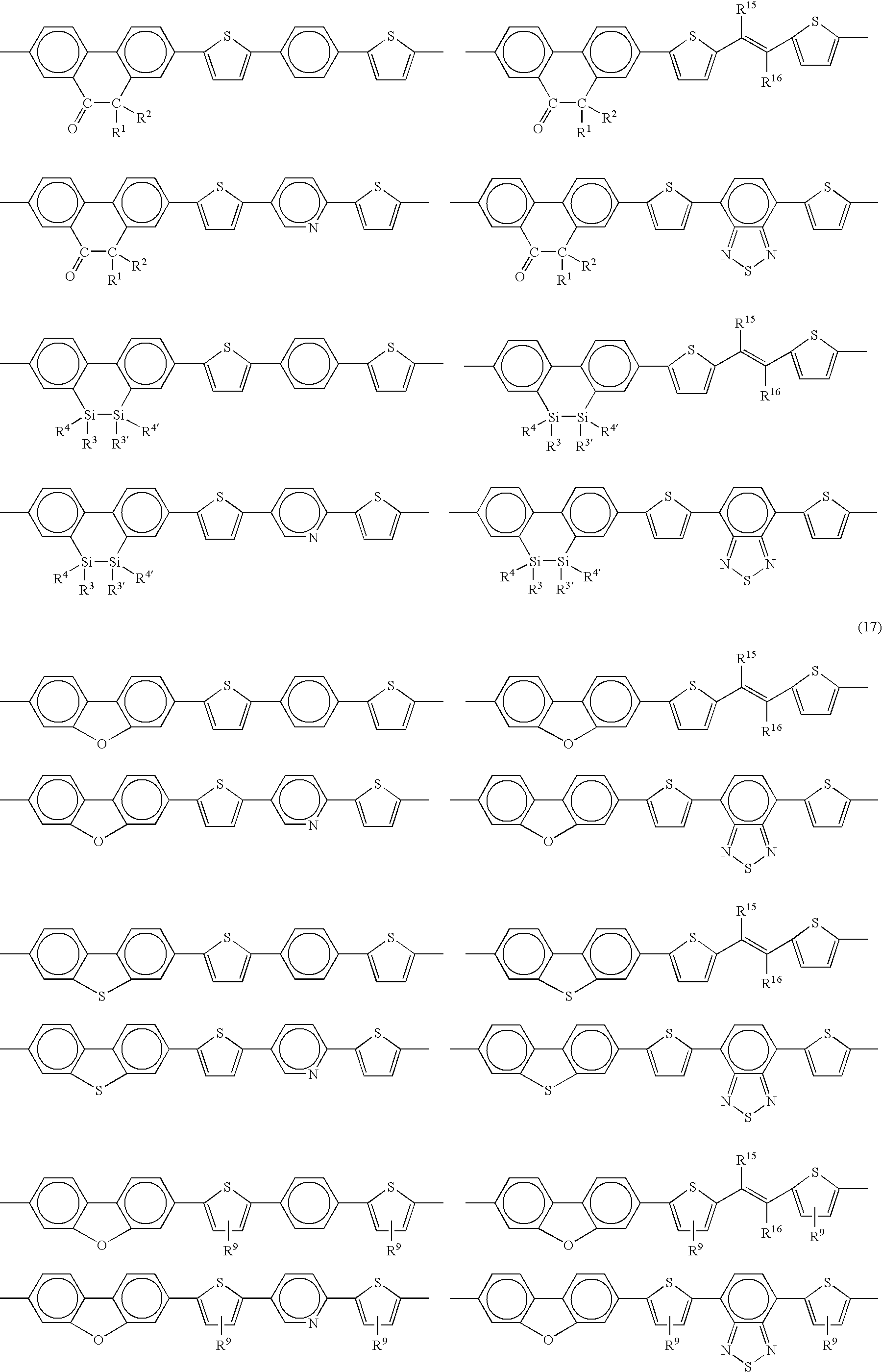 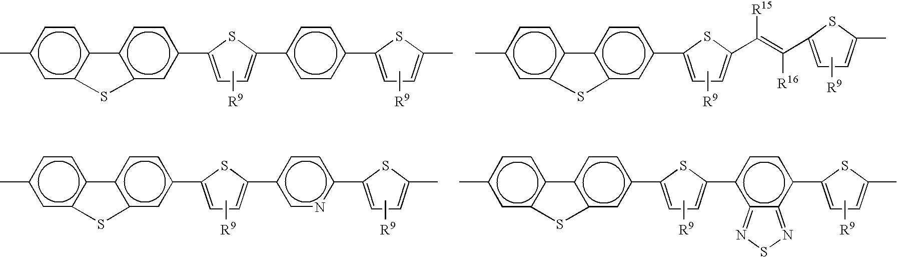
(wherein, R¹ to R⁹, R¹⁵ and R¹⁶ represent the same meanings as described above. R^{1′} to R^{4′} represent the same meanings as for R¹ to R⁴).

Of them, preferable are groups of the formulae (9), (14), (15) and (17) and groups having further a substituent on an aromatic hydrocarbon group or heterocycle in these groups, and further preferable are groups of the formulae (9) and (15) and groups having further a substituent on an aromatic hydrocarbon group or heterocycle in these groups. As the substituent, exemplified are halogen atoms, alkyl groups, alkyloxy group, alkylthio groups, aryl groups, aryloxy groups, arylthio groups, arylalkyl groups, arylalkyloxy groups, arylalkylthio groups, acyl groups, acyloxy groups, amide groups, acid imide groups, imine residues, amino groups, substituted amino groups, substituted silyl groups, substituted silyloxy groups, substituted silylthio groups, substituted silylamino groups, mono-valent heterocyclic groups, heteroaryloxy groups, heteroarylthio groups, arylalkenyl groups, arylethynyl groups, carboxyl group, alkyloxycarbonyl groups, aryloxycarbonyl groups, arylalkyloxycarbonyl groups, heteroaryloxycarbonyl groups or cyano groups, and the substituents may mutually be connected to form a ring.

In the above-described formula (1), (2) or (3), exemplified are the halogen atom are fluorine, chlorine, bromine and iodine.

The alkyl group may be any of linear, branched or cyclic, may have a substituent, and the carbon number is usually 1 to about 20, and specific examples thereof include a methyl group, ethyl group, propyl group, i-propyl group, butyl group, i-butyl group, t-butyl group, pentyl group, hexyl group, cyclohexyl group, heptyl group, octyl group, 2-ethylhexyl group, nonyl group, decyl group, 3,7-dimethyloctyl group, lauryl group, trifluoromethyl group, pentafluoroethyl group, perfluorobutyl group, perfluorohexyl group, perfluorooctyl group and the like.

The alkyloxy group may be any of linear, branched or cyclic, may have a substituent, and the carbon number is usually 1 to about 20, and specific examples thereof include a methoxy group, ethoxy group, propyloxy group, i-propyloxy group, butoxy group, i-butoxy group, t-butoxy group, pentyloxy group, hexyloxy group, cyclohexyloxy group, heptyloxy group, octyloxy group, 2-ethylhexyloxy group, nonyloxy group, decyloxy group, 3,7-dimethyloctyloxy group, lauryloxy group, trifluoromethoxy group, pentafluoroethoxy group, perfluorobutoxy group, perfluorohexyl group, perfluorooctyl group, methoxymethyloxy group, 2-methoxyethyloxy group and the like.

The alkylthio group may be any of linear, branched or cyclic, may have a substituent, and the carbon number is usually 1 to about 20, and specific examples thereof include a methylthio group, ethylthio group, propylthio group, i-propylthio group, butylthio group, i-butylthio group, t-butylthio group, pentylthio group, hexylthio group, cyclohexylthio group, heptylthio group, octylthio group, 2-ethylhexylthio group, nonylthio group, decylthio group, 3,7-dimethyloctylthio group, laurylthio group, trifluoromethylthio group and the like.

The aryl group may have a substituent, and the carbon number is usually about 3 to 60, and specific examples thereof include a phenyl group, C₁-C₁₂ alkoxyphenyl group (C₁-C₁₂ means a carbon number of 1 to 12, applicable also in the followings), C₁-C₁₂ alkylphenyl group, 1-naphthyl group, 2-naphthyl group, pentafluorophenyl group, pyridyl group, pyridazinyl group, pyrimidyl group, pirazyl group, triazyl group and the like.

The aryloxy group may have a substituent on an aromatic ring, and the carbon number is usually about 3 to 60, and specific examples thereof include a phenoxy group, C₁-C₁₂ alkoxyphenoxy group, C₁-C₁₂ alkylphenoxy group, 1-naphthyloxy group, 2-naphthyloxy group, pentafluorophenyloxy group, pyridyloxy group, pyridazinyloxy group, pyrimidyloxy group, pirazyloxy group, triazyloxy group and the like.

The arylthio group may have a substituent on an aromatic ring, and the carbon number is usually about 3 to 60, and specific examples thereof include a phenylthio group, C₁-C₁₂ alkoxyphenylthio group, C₁-C₁₂ alkylphenylthio group, 1-naphthylthio group, 2-naphthylthio group, pentafluorophenylthio group, pyridylthio group, pyridazinylthio group, pyrimidylthio group, pirazylthio group, triazylthio group and the like.

The arylalkyl group may have a substituent, and the carbon number is usually about 7 to 60, and specific examples thereof include a phenyl-C₁-C₁₂ alkyl group, C₁-C₁₂ alkoxyphenyl-C₁-C₁₂ alkyl group, C₁-C₁₂ alkylphenyl-C₁-C₁₂ alkyl group, 1-naphthyl-C₁-C₁₂ alkyl group, 2-naphthyl-C₁-C₁₂ alkyl group and the like.

The arylalkyloxy group may have a substituent, and the carbon number is usually about 7 to 60, and specific examples thereof include a phenyl-C₁-C₁₂ alkoxy group, C₁-C₁₂ alkoxyphenyl-C₁-C₁₂ alkoxy group, C₁-C₁₂ alkylphenyl-C₁-C₁₂ alkoxy group, 1-naphthyl-C₁-C₁₂ alkoxy group, 2-naphthyl-C₁-C₁₂ alkoxy group and the like.

The arylalkylthio group may have a substituent, and the carbon number is usually about 7 to 60, and specific examples thereof include a phenyl-C₁-C₁₂ alkylthio group, C₁-C₁₂ alkoxyphenyl-C₁-C₁₂ alkylthio group, C₁-C₁₂ alkylphenyl-C₁-C₁₂ alkylthio group, 1-naphthyl-C₁-C₁₂ alkylthio group, 2-naphthyl-C₁-C₁₂ alkylthio group and the like.

The acyl group has a carbon number of usually about 2 to 20, and specific examples thereof include an acetyl group, propionyl group, butyryl group, isobutyryl group, pivaloyl group, benzoyl group, trifluoroacetyl group, pentafluorobenzoyl group and the like.

The acyloxy group has a carbon number of usually about 2 to 20, and specific examples thereof include an acetoxy group, propionyloxy group, butyryloxy group, isobutyryloxy group, pivaloyloxy group, benzoyloxy group, trifluoroacetyloxy group, pentafluorobenzoyloxy group and the like.

The amide group has a carbon number of usually about 2 to 20, preferably 2 to 18, and specific examples thereof include a formamide group, acetamide group, propioamide group, butyroamide group, benzamide group, trifluoroacetamide group, pentafluorobenzamide group, diformamide group, diacetamide group, dipropioamide group, dibutyroamide group, dibenzamide group, ditrifluoroacetamide group, dipentafluorobenzamide group and the like.

The acid imide group includes residues obtained by removing a hydrogen atom connected to a nitrogen atom of acid imide, and the carbon number is usually about 2 to 60, preferably 2 to 48. Specifically, the following groups are exemplified.

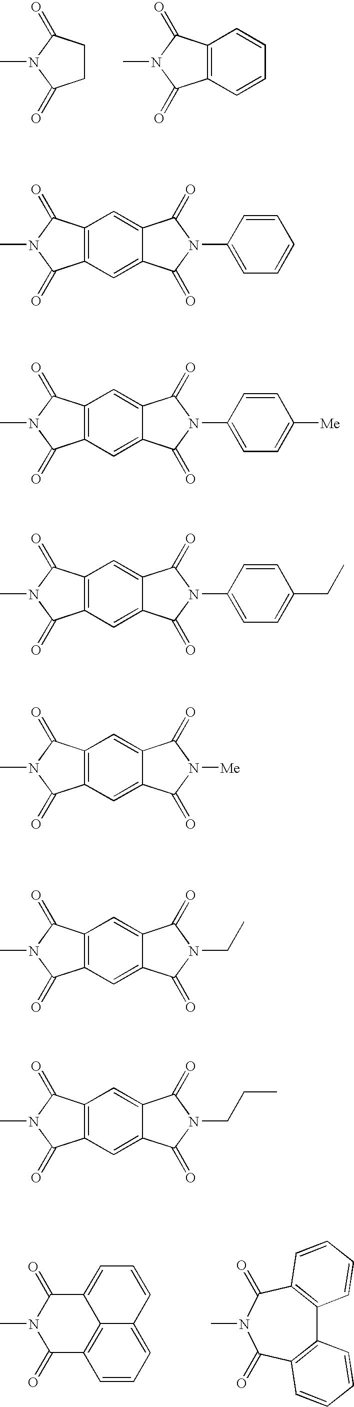

The imine residue includes residues obtained by removing one hydrogen atom from imine compounds (meaning organic compounds having —N═C— in the molecule. Examples thereof include aldimines, ketimines and compounds obtained by substituting a hydrogen atom on N of these compounds by an alkyl group and the like), and the carbon number is usually about 2 to 20, preferably 2 to 18. Specifically, groups of the following structural formulae and the like are exemplified.

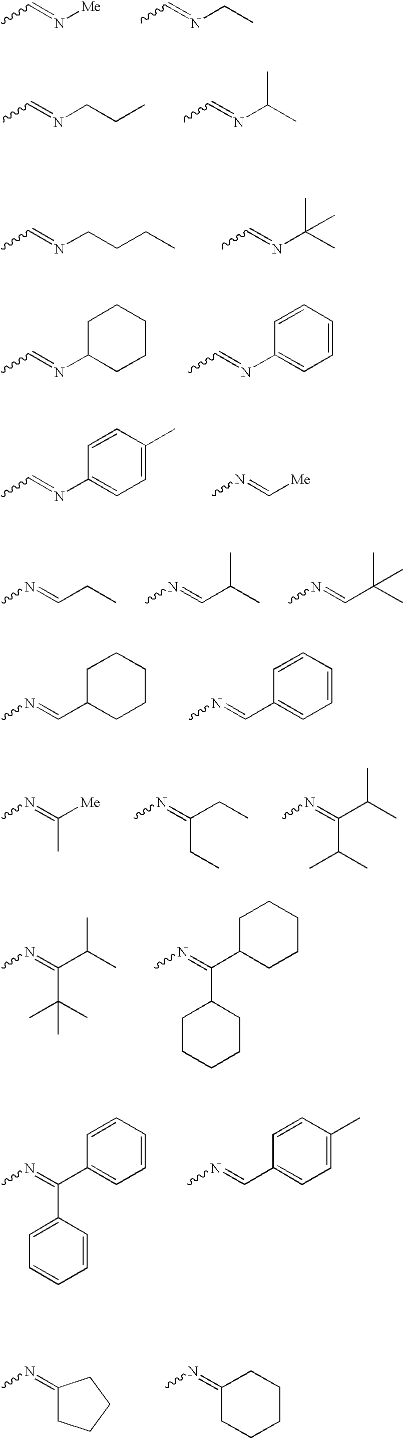

The substituted amino group includes amino groups substituted with one or two groups selected from alkyl groups, aryl groups, arylalkyl groups and mono-valent heterocyclic groups, and the alkyl group, aryl group, arylalkyl group or mono-valent heterocyclic group may have a substituent. The substituted amino group has a carbon number of usually 1 to about 40, and specific examples thereof include a methylamino group, dimethylamino group, ethylamino group, diethylamino group, propylamino group, dipropylamino group, isopropylamino group, diisopropylamino group, butylamino group, isobutylamino group, t-butylamino group, pentylamino group, hexylamino group, cyclohexylamino group, heptylamino group, octylamino group, 2-ethylhexylamino group, nonylamino group, decylamino group, 3,7-dimethyloctylamino group, laurylamino group, cyclopentylamino group, dicyclopentylamino group, cyclohexylamino group, dicyclohexylamino group, pyrrolydyl group, piperidyl group, ditrifluoromethylamino group, phenylamino group, diphenylamino group, C₁-C₁₂ alkoxyphenylamino group, di(C₁-C₁₂ alkoxyphenyl)amino group, di(C₁-C₁₂ alkylphenyl)amino group, 1-naphthylamino group, 2-naphthylamino group, pentafluorophenylamino group, pyridylamino group, pyridazinylamino group, pyrimidylamino group, pyradylamino group, triazylamino group, phenyl-C₁-C₁₂ alkylamino group, C₁-C₁₂ alkoxyphenyl-C₁-C₁₂ alkylamino group, di(C₁-C₁₂ alkoxyphenyl-C₁-C₁₂ alky)lamino group, di(C₁-C₁₂ alkylphenyl-C₁-C₁₂ alky)lamino group, 1-naphthyl-C₁-C₁₂ alkylamino group, 2-naphthyl-C₁-C₁₂ alkylamino group and the like.

The substituted silyl group includes silyl groups substituted with 1, 2 or 3 groups selected from alkyl groups, aryl groups, arylalkyl groups and mono-valent heterocyclic groups, and the carbon number is usually 1 to about 60, preferably 3 to 48. The alkyl group, aryl group, arylalkyl group or mono-valent heterocyclic group may have a substituent.

Specific examples thereof include a trimethylsilyl group, triethylsilyl group, tripropylsilyl group, tri-1-propylsilyl group, dimethyl-1-propylsilyl group, diethyl-1-propylsilyl group, t-butylsilyldimethylsilyl group, pentyldimethylsilyl group, hexyldimethylsilyl group, heptyldimethylsilyl group, octyldimethylsilyl group, 2-ethylhexyl-dimethylsilyl group, nonyldimethylsilyl group, decyldimethylsilyl group, 3,7-dimethyloctyl-dimethylsilyl group, lauryldimethylsilyl group, phenyl-C₁-C₁₂ alkylsilyl group, C₁-C₁₂ alkoxyphenyl-C₁-C₁₂ alkysilyl group, C₁-C₁₂ alkylphenyl-C₁-C₁₂ alkysilyl group, 1-naphthyl-C₁-C₁₂ alkylsilyl group, 2-naphthyl-C₁-C₁₂ alkylsilyl group, phenyl-C₁-C₁₂ alkyldimethylsilyl group, triphenylsilyl group, tri-p-xylylsilyl group, tribenzylsilyl group, diphenylmethylsilyl group, t-butyldiphenylsilyl group, dimethylphenylsilyl group and the like.

The substituted silyloxy group includes silyloxy groups (H₃SiO—) substituted with 1, 2 or 3 groups selected from alkyl groups, aryl groups, arylalkyl groups and mono-valent heterocyclic groups. The alkyl group, aryl group, arylalkyl group or mono-valent heterocyclic group may have a substituent.

The substituted silyloxy group has a carbon number of usually 1 to about 60, preferably 3 to 30, and specific examples thereof include a trimethylsilyloxy group, triethylsilyloxy group, tri-n-propylsilyloxy group, tri-1-propylsilyloxy group, t-butylsilyldimethylsilyloxy group, triphenylsilyloxy group, tri-p-xylylsilyloxy group, tribenzylsilyloxy group, diphenylmethylsilyloxy group, t-butyldiphenylsilyloxy group, dimethylphenylsilyloxy group and the like.

The substituted silylthio group includes silylthio groups (H₃SiS—) substituted with 1, 2 or 3 groups selected from alkyl groups, aryl groups, arylalkyl groups and mono-valent heterocyclic groups. The alkyl group, aryl group, arylalkyl group or mono-valent heterocyclic group may have a substituent.

The substituted silylthio group has a carbon number of usually 1 to about 60, preferably 3 to 30, and specific examples thereof include a trimethylsilylthio group, triethylsilylthio group, tri-n-propylsilylthio group, tri-1-propylsilylthio group, t-butylsilyldimethylsilylthio group, triphenylsilylthio group, tri-p-xylylsilylthio group, tribenzylsilylthio group, diphenylmethylsilylthio group, t-butyldiphenylsilylthio group, dimethylphenylsilylthio group and the like.

The substituted silylamino group includes silylamino groups (H₃SiNH— or (H₃Si)₂N—) substituted with 1 to 6 groups selected from alkyl groups, aryl groups, arylalkyl groups and mono-valent heterocyclic groups. The alkyl group, aryl group, arylalkyl group or mono-valent heterocyclic group may have a substituent.

The substituted silylamino group has a carbon number of usually 1 to about 120, preferably 3 to 60, and specific examples thereof include a trimethylsilylamino group, triethylsilylamino group, tri-n-propylsilylamino group, tri-1-propylsilylamino group, t-butylsilyldimethylsilylamino group, triphenylsilylamino group, tri-p-xylylsilylamino group, tribenzylsilylamino group, diphenylmethylsilylamino group, t-butyldiphenylsilylamino group, dimethylphenylsilylamino group, di(trimethylsilyl)amino group, di(triethylsilyl)amino group, di(tri-n-propylsilyl)amino group, di(tri-i-propylsilyl)amino group, di(t-butylsilyldimethylsilyl)amino group, di(triphenylsilyl)amino group, di(tri-p-xylylsilyl)amino group, di(tribenzylsilyl)amino group, di(diphenylmethylsilyl)amino group, di(t-butyldiphenylsilyl)amino group, di(dimethylphenylsilyl)amino group and the like.

The mono-valent heterocyclic group means an atom group remaining after removing one hydrogen atom from a heterocyclic compound, and the carbon number is usually about 4 to 60, and specific examples thereof include a thienyl group, C₁-C₁₂ alkylthienyl group, pyrrolyl group, furyl group, pyridyl group, C₁-C₁₂ alkylpyridyl group, imidazolyl group, pyrazolyl group, triazolyl group, oxazolyl group, thiazole group, thiadiazole group and the like.

As the mono-valent heterocyclic group in the heteroaryloxy group (group of Q¹-O—, Q¹ represents a mono-valent heterocyclic group), the heteroarylthio group (group of Q²-S—, Q² represents a mono-valent heterocyclic group) and the heteroaryloxycarbonyl group (group of Q³-O(C═O)—, Q³ represents a mono-valent heterocyclic group), exemplified are those groups as exemplified for the above-described heterocyclic group.

For example, the heteroaryloxy group has a carbon number of usually about 4 to 60, and specific examples thereof include a thienyloxy group, C₁-C₁₂ alkylthienyloxy group, pyrrolyloxy group, furyloxy group, pyridyloxy group, C₁-C₁₂ alkylpyridyloxy group, imidazolyloxy group, pyrazolyloxy group, triazolyloxy group, oxazolyloxy group, thiazoleoxy group, thiadiazoleoxy group and the like.

The heteroarylthio group has a carbon number of usually about 4 to 60, and specific examples thereof include a thienylmercapto group, C₁-C₁₂ alkylthienylmercapto group, pyrrolylmercapto group, furylmercapto group, pyridylmercapto group, C₁-C₁₂ alkylpyridylmercapto group, imidazolylmercapto group, pyrazolylmercapto group, triazolylmercapto group, oxazolylmercapto group, thiazolemercapto group, thiadiazolemercapto group and the like.

The arylalkenyl group has a carbon number of usually about 8 to 50, and the aryl group and the alkenyl group in the arylalkenyl group are the same as the aryl group and alkenyl group described above, respectively. Specific examples thereof include a 1-arylvinyl group, 2-arylvinyl group, 1-aryl-1-propylenyl group, 2-aryl-1-propylenyl group, 2-aryl-2-propylenyl group, 3-aryl-2-propylenyl group and the like. Arylalkadienyl groups such as a 4-aryl-1,3-butadienyl group and the like are also included.

The arylethynyl group has a carbon number of usually about 8 to 50, and as the aryl group in the arylalkynyl group, the aryl groups described above are mentioned.

The alkyloxycarbonyl group has a carbon number of usually about 2 to 20, and specific examples thereof include a methoxycarbonyl group, ethoxycarbonyl group, propyloxycarbonyl group, i-propyloxycarbonyl group, butoxycarbonyl group, i-butoxycarbonyl group, t-butoxycarbonyl group, pentyloxycarbonyl group, hexyloxycarbonyl group, cyclohexyloxycarbonyl group, heptyloxycarbonyl group, octyloxycarbonyl group, 2-ethylhexyloxycarbonyl group, nonyloxycarbonyl group, decyloxycarbonyl group, 3,7-dimethyloctyloxycarbonyl group, lauryloxycarbonyl group, trifluoromethoxycarbonyl group, pentafluoroethoxycarbonyl group, perfluorobutoxycarbonyl group, perfluorohexyloxycarbonyl group, perfluorooctyloxycarbonyl group and the like.

The aryloxycarbonyl group has a carbon number of usually about 7 to 60, and specific examples thereof include a phenoxycarbonyl group, C₁-C₁₂ alkoxyphenoxycarbonyl group, C₁-C₁₂ alkylphenoxycarbonyl group, 1-naphthyloxycarbonyl group, 2-naphthyloxycarbonyl group, pentafluorophenyloxycarbonyl group, and the like.

The arylalkyloxycarbonyl group has a carbon number of usually about 8 to 60, and specific examples thereof include a phenyl-C₁-C₁₂ alkoxycarbonyl group, C₁-C₁₂ alkoxyphenyl-C₁-C₁₂ alkoxycarbonyl group, C₁-C₁₂ alkylphenyl-C₁-C₁₂ alkoxycarbonyl group, 1-naphthyl-C₁-C₁₂ alkoxycarbonyl group, 2-naphthyl-C₁-C₁₂ alkoxycarbonyl group and the like.

The heteroaryloxycarbonyl group (group of Q⁴-O(C═O)—, Q⁴ represents a mono-valent heterocyclic group) has a carbon number of usually about 2 to 60, and specific examples thereof include a thienyloxycarbonyl group, C₁-C₁₂ alkylthienyloxycarbonyl group, pyrrolyloxycarbonyl group, furyloxycarbonyl group, pyridyloxycarbonyl group, C₁-C₁₂ alkylpyridyloxycarbonyl group, imidazolyloxycarbonyl group, pyrazolyloxycarbonyl group, triazolyloxycarbonyl group, oxazolyloxycarbonyl group, thiazoleoxycarbonyl group, thiadiazoleoxycarbonyl group and the like.

The polymer compound of the present invention may contain each two or more of the above-described formula (1), (2) or (3).

The polymer compound of the present invention may contain a repeating unit other than the above-described formulae (1), (2) and (3) in a range not deteriorating electron transportability or hole transportability. The sum of repeating units of the formula (1) and the formula (2) or the sum of repeating units of the formula (1), the formula (2) and the formula (3) is preferably 10 mol % or more, more preferably 50 mol % or more, further preferably 80 mol % or more based on all repeating units.

When the polymer compound of the present invention contains the formula (1) and the formula (2), the molar ratio of the formula (1) to the formula (2) is preferably in a range of 3:1 to 1:3, more preferably 2:1 to 1:2, further preferably about 1:1.

When the polymer compound of the present invention contains the formula (1), the formula (2) and the formula (3), the molar ratio of the sum of the formula (2) and the formula (3) to the formula (1) is preferably in a range of 3:1 to 1:3, more preferably 2:1 to 1:2, further preferably about 1:1.

The polymer compound of the present invention may be an alternating, random, block or graft copolymer, alternatively, a polymer compound having a structure which is intermediate between them, for example, a random copolymer partaking a blocking property. Further, those having branching in the main chain and having three or more end parts, and dendrimers are also included. Preferable are alternating, block or graft copolymers, more preferable are alternating copolymers. Among block or graft copolymers, those containing a structure of the formula (7) or a structure of the formula (8) in a block or graft part are preferable.

Among the polymer compounds of the present invention, mentioned as the polymer compound having the structure (7) and the polymer compound having the structure (8) are, for example, polymer compounds having an alternating copolymer structure of the following formula (7-1) and polymer compounds having a copolymer structure of the following formula (8-1).

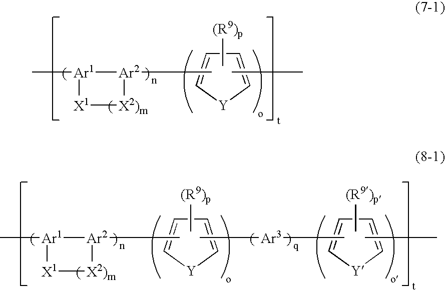

Here, t represents the number of repetition of the structure (7) or the structure (8), and t is, though varying depending on the structure of a repeating unit, usually about 2 to 100000, preferably about 5 to 10000.

In the polymer compound of the present invention, repeating units may be coupled by non-conjugated units, or the non-conjugated units may be contained in repeating units. As the connection structure, exemplified are those described below and those obtained by combining two or more of those described below. Here, Rs represent each independently a hydrogen atom, halogen atom, alkyl group, alkyloxy group, alkylthio group, aryl group, aryloxy group, arylthio group, arylalkyl group, arylalkyloxy group, arylalkylthio group, acyl group, acyloxy group, amide group, acid imide group, imine residue, amino group, substituted amino group, substituted silyl group, substituted silyloxy group, substituted silylthio group, substituted silylamino group, mono-valent heterocyclic group, heteroaryloxy group, heteroarylthio group, arylalkenyl group, arylethynyl group, carboxyl group, alkyloxycarbonyl group, aryloxycarbonyl group, arylalkyloxycarbonyl group, heteroaryloxycarbonyl group or cyano group, and Ar represents a hydrocarbon group having 6 to 60 carbon atoms.

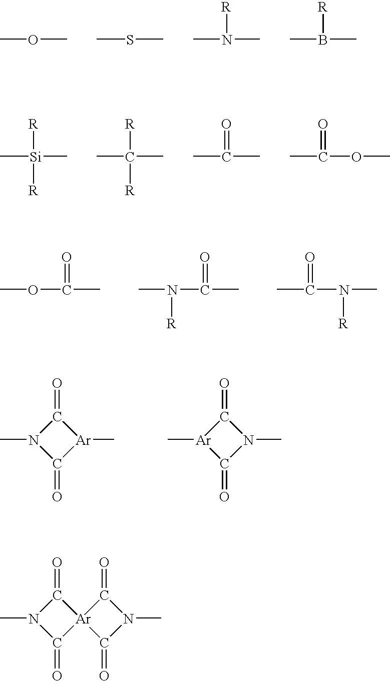

An end group of the polymer compound of the present invention may be protected by a stable group since when a polymerization active group remains intact, there is s possibility of decrease in properties and durability when made into a device. Those having a conjugated bond consecutive to a conjugated structure of the main chain are preferable, and for example, structures connecting to an aryl group or heterocyclic group via a carbon-carbon bond are exemplified. Specifically, substituents described in (chemical formula 10) in Japanese Patent Application Laid-Open (JP-A) No. 9-45478, and the like are exemplified.

The polymer compound of the present invention may have a group of the following formula (18), (19) or (20) at an end of the main chain.

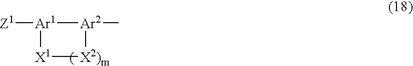

In the formula, Ar¹, Ar², X¹, X² and m represent the same meanings as described above. Z¹ represents a hydrogen atom, alkyl group, alkyloxy group, alkylthio group, aryl group, aryloxy group, arylthio group, arylalkyl group, arylalkyloxy group, arylalkylthio group, substituted amino group, substituted silyl group, mono-valent heterocyclic group, heteroaryloxy group, heteroarylthio group, arylalkenyl group or arylethynyl group.

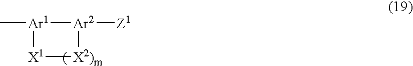

In the formula, Ar¹, Ar², X¹, X², Z¹ and m represent the same meanings as described above.

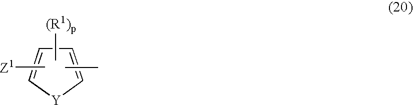

In the formula, Y, R¹, Z¹ and p represent the same meanings as described above.

The polymer compound of the present invention has a polystyrene-reduced number-average molecular weight of about 10³ to 10⁸, preferably 10⁴ to 10⁶.

As the solvent for the polymer compound of the present invention, exemplified are unsaturated hydrocarbon-based solvents such as toluene, xylene, mesitylene, tetralin, decalin, n-butylbenzene and the like, halogenated saturated hydrocarbon-based solvents such as carbon tetrachloride, chloroform, dichloromethane, dichloroethane, chlorobutane, bromobutane, chloropentane, bromopentane, chlorohexane, bromohexane, chlorocyclohexane, bromocyclohexane and the like, halogenated unsaturated hydrocarbon-based solvents such as chlorobenzene, dichlorobenzene, trichlorobenzene and the like, ether-based solvents such as tetrahydrofuran, tetrahydropyran and the like. Depending on the structure and molecular weight of the polymer compound, the polymer compound can be usually dissolved in an amount of 0.1 wt % or more in these solvents.

Among the polymer compounds of the present invention, polymer compounds having liquid crystallinity are preferable. The polymer compound having liquid crystallinity means that the polymer compound of a molecule containing the polymer compound shows a liquid crystalline phase. The liquid crystalline phase can be confirmed by a polarization microscope, and differential scanning calorimetry, X-ray diffraction measurement and the like.

The polymer compound having liquid crystallinity, when used as a material for organic thin film transistors for example, is useful for enhancing electron mobility or hole mobility. The polymer compound having liquid crystallinity is known to show optical or electrical anisotropy by being oriented (Synthetic Meals 119 (2001)537).

The method for producing the polymer compound of the present invention will be described below.

The polymer compound of the present invention can be prepared, for example, by condensation polymerization using a compound of the following formula (21), a compound of the following formula (22) and a compound of the following formula (23) as raw materials.

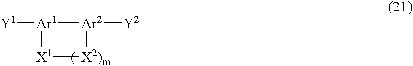

In the formula, Ar¹, Ar², X¹, X² and m represent the same meanings as described above. Y¹ and Y² represent each independently a halogen atom, alkyl sulfonate group, aryl sulfonate group, arylalkyl sulfonate group, borate group, sulfonylmethyl group, phosphoniummethyl group, phosphonatemethyl group, mono-halogenated methyl group, boric group, formyl group or vinyl group.

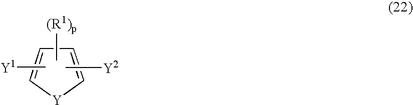

In the formula, Y, R¹, Y¹, Y² and p represent the same meanings as described above.

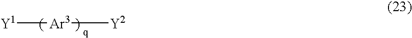

In the formula, Ar³, Y¹, Y² and q represent the same meanings as described above.

It is preferable that Y¹ and Y² represent each independently a halogen atom, alkyl sulfonate group, aryl sulfonate group, arylalkyl sulfonate group, borate group or boric group from the standpoint of synthesis of compounds of the above-described formulae (21), (22) and (23) and easiness of a condensation polymerization reaction.

The polymer compound of the present invention can be condensation-polymerized using a compound of the following formula (24), (25), (26) or (27) in addition to (21), (22) and (23), to successfully control its end structure.

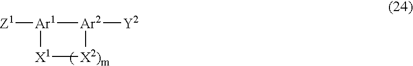

In the formula, Ar¹, Ar², X¹, X², Y² and m represent the same meanings as described above. Z¹ represents a hydrogen atom, alkyl group, alkyloxy group, alkylthio group, aryl group, aryloxy group, arylthio group, arylalkyl group, arylalkyloxy group, arylalkylthio group, substituted amino group, substituted silyl group, mono-valent heterocyclic group, heteroaryloxy group, heteroarylthio group, arylalkenyl group or arylethynyl group.

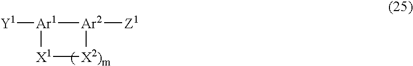

In the formula, Ar¹, Ar², X¹, X², Y¹, Z¹ and m represent the same meanings as described above.

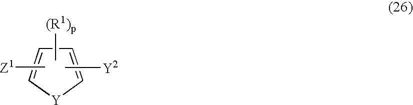

In the formula, Ar¹, Ar², X¹, X², Y², Z¹ and m represent the same meanings as described above.

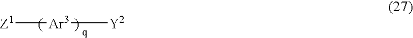

In the formula, Ar³, Y², Z¹ and q represent the same meanings as described above.

In compounds of the above-described formulae (24) to (27), Y¹ and Y² preferably represent each independently a halogen atom, alkyl sulfonate group, aryl sulfonate group, arylalkyl sulfonate group, borate group or boric group, more preferably a halogen atom from the standpoint of synthesis of the above-described compounds and easiness of a condensation polymerization reaction.

As the alkyl sulfonate group in the formulae (21) to (27), exemplified are a methane sulfonate group, ethane sulfonate group, trifluoromethane sulfonate group and the like, as the aryl sulfonate group, exemplified are a benzene sulfonate group, p-toluene sulfonate group and the like, and as the arylalkyl sulfonate group, exemplified are a benzyl sulfonate group and the like.

As the borate group, groups of the following formulae are exemplified.

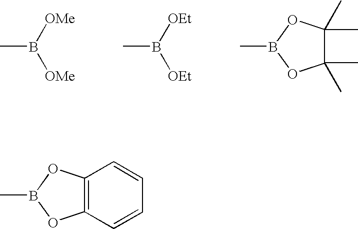

As the sulfonylmethyl group, groups of the following formulae are exemplified.

—CH₂S⁺Me₂X⁻, —CH₂S⁺Ph₂X⁻, (X represents a halogen atom)

As the phosphoniummethyl group, groups of the following formula are exemplified.

—CH₂P⁺Ph₃X⁻, (X represents a halogen atom)

As the phosphonatemethyl group, groups of the following formula are exemplified.

—CH₂PO(OR′)₂

(R′ represents an alkyl group, aryl group or arylalkyl group)

As the mono-halogenated methyl group, exemplified are a methyl fluoride group, methyl chloride group, methyl bromide group and methyl iodide group.

As the reaction method to be used for production of the polymer compound of the present invention, for example, a method of polymerization by the Suzuki coupling reaction, a method of polymerization by the Grignard reaction, a method of polymerization using a Ni(0) catalyst, a method of polymerization using an oxidizer such as FeCl₃ and the like, a method of electrochemical oxidation polymerization, a method by decomposition of an intermediate polymer compound having a suitable releasing group, and the like are exemplified.

Of them, methods of polymerization by the Witting reaction, polymerization by the Heck reaction, polymerization by the Horner-Wadsworth-Emmons reaction, polymerization by the Knoevenagel reaction and polymerization by the Suzuki coupling reaction, and a method of polymerization by the Grignard reaction and a method of polymerization using a Ni(0) catalyst are preferable since structure control is easy. Further, a method of polymerization by the Suzuki coupling reaction, a method of polymerization by the Grignard reaction and a method of polymerization using a Ni(0) catalyst are preferable because of easy availability of raw materials and simplicity of a polymerization reaction operation.

A monomer, if necessary, is dissolved in an organic solvent, and can be reacted at temperatures of not lower than the melting point and not higher than the boiling point of the organic solvent using, for example, an alkali or a suitable catalyst. For example, known methods described in “Organic Reactions”, vol. 14, p. 270-490, John Wiley & Sons, Inc., 1965, “Organic Reactions”, vol. 27, p. 345-390, John Wiley & Sons, Inc., 1982, “Organic Syntheses”, Collective Volume VI, p. 407-411, John Wiley & Sons, Inc., 1988, “Chemical Rev.”, vol. 95, p. 2457 (1995), J. Organomet. Chem., vol. 576, p. 147 (1999), J. Prakt. Chem., vol. 336, p. 247 (1994), Makromol. Chem., Macromol. Symp., vol. 12, p. 229 (1987) and the like can be used.

It is preferable that the organic solvent to be used is subjected to a deoxidation treatment sufficiently and the reaction is progressed under an inert atmosphere for generally suppressing side reactions though varying depending on compounds and reactions to be used. A dehydration treatment is preferably conducted because of the same reason (excepting cases of reactions with water in two-phase system such as the Suzuki coupling reaction).

For carrying out the reaction, an alkali or suitable catalyst is appropriately added. These may be advantageously selected depending on the reaction to be used. As the alkali or catalyst, those dissolving sufficiently in a solvent to be used in the reaction are preferable. As the method of mixing an alkali or catalyst, exemplified are methods in which a solution of an alkali or catalyst is added slowly while stirring the reaction liquid under an inert atmosphere such as argon, nitrogen and the like, or in contrast, the reaction liquid is added slowly to a solution of an alkali or catalyst.

When the polymer compound of the present invention is used as a material for a polymer thin film device, its purity influences the property of the device, thus, it is preferable that a monomer before polymerization is purified by a method such as distillation, sublimation purification, re-crystallization and the like before polymerization, and it is preferable that after synthesis, a purification treatment such as re-deposition purification, chromatography fractionation and the like is performed.

In the method of producing the polymer compound of the present invention, monomers may be mixed in a lump and reacted, or, if necessary, may be divided and mixed.

Regarding specific reaction conditions, in the case of the Wittig reaction, Horner reaction, Knoevengel reaction and the like, an alkali in an amount of equivalent, preferably 1 to 3 equivalents is used based on functional groups in monomers and reacted. The alkali is not particularly restricted, and for example, metal alcoholates such as potassium-t-butoxide, sodium-t-butoxide, sodium ethylate, lithium methylate and the like, hydride reagents such as sodium hydride and the like, amides such as sodiumamide, and the like can be used. As the solvent, N,N-dimethylformamide, tetrahydrofuran, dioxane, toluene and the like can be used. The reaction can be progressed usually at reaction temperatures of from room temperature to about 150° C. The reaction time is, for example, from 5 minutes to 40 hours, and times for sufficient progress of polymerization are permissible, and since leaving for a long time after completion of the reaction is not necessary, the reaction time is preferably 10 minutes to 24 hours. When the concentration in the reaction is too thin, the reaction efficiency is poor, and when too dense, control of the reaction becomes difficult, thus, the concentration may be appropriately selected in a range from about 0.01 wt % to the maximum soluble concentration, and usually in a range of 0.1 wt % to 20 wt %. In the case of the Heck reaction, monomers are reacted in the presence of a base such as triethylamine and the like using a palladium catalyst. A solvent having a relatively high boiling point such as N,N-dimethylformamide, N-methylpyrrolidone and the like is used, the reaction temperature is about 80 to 160° C. and the reaction time is about 1 to 100 hours.

In the case of the Suzuki coupling reaction, palladium[tetrakis(triphenylphosphine)], palladium acetates and the like, for example, are used as a catalyst, and an inorganic base such as potassium carbonate, sodium carbonate, barium hydroxide and the like, an organic base such as triethylamine and the like, and an inorganic salt such as cesium fluoride and the like are added in an amount of equivalent or more, preferably 1 to 10 equivalents and reacted. It may also be permissible that an inorganic salt is used in the form of aqueous solution and reacted in two-phase system. As the solvent, N,N-dimethylformamide, toluene, dimethoxyethane, tetrahydrofuran and the like are exemplified. Depending on the solvent, temperatures of about 50 to 160° C. are suitably used. It may also be permissible that the temperature is raised up to near the boiling point of a solvent to cause reflux. The reaction time is from about 1 hour to 200 hours.

In the case of the Grignard reaction, there are exemplified methods in which a halide and metal Mg are reacted in an ether-based solvent such as tetrahydrofuran, diethyl ether, dimethoxyethane and the like to give a Grignard reagent solution which is mixed with a monomer solution prepared separately, and a nickel or palladium catalyst is added while watching an excess reaction, then, the temperature is raised and the reaction is caused while refluxing. The Grignard reagent is used in an amount of equivalent or more, preferably 1 to 1.5 equivalents, more preferably 1 to 1.2 equivalents based on monomers. Also in the case of polymerization by other methods than these methods, the reaction can be carried out according to known methods.

The reaction method is not particularly restricted and the reaction can be carried out in the presence of a solvent. The reaction temperature is preferably from −80° C. to the boiling point of the solvent.

As the solvent to be used in the reaction, exemplified are saturated hydrocarbons such as pentane, hexane, heptane, octane, cyclohexane and the like, unsaturated hydrocarbons such as benzene, toluene, ethylbenzene, xylene and the like, halogenated saturated hydrocarbons such as carbon tetrachloride, chloroform, dichloromethane, chlorobutane, bromobutane, chloropentane, bromopentane, chlorohexane, bromohexane, chlorocyclohexane, bromocyclohexane and the like, halogenated unsaturated hydrocarbons such as chlorobenzene, dichlorobenzene, trichlorobenzene and the like, alcohols such as methanol, ethanol, propanol, isopropanol, butanol, t-butyl alcohol and the like, carboxylic acids such as formic acid, acetic acid, propionic acid and the like, ethers such as dimethyl ether, diethyl ether, methyl-t-butyl ether, tetrahydrofuran, tetrahydropyran, dioxane and the like, inorganic acids such as hydrochloric acid, hydrobromic acid, hydrofluoric acid, sulfuric acid, nitric acid and the like, and these may be used in the form of single solvent or mixed solvent.

After the reaction, usual post treatments can be conducted such as, for example, quenching with water before extraction with an organic solvent and distilling off the solvent, and the like. Isolation and purification of the product can be carried out by methods such as fractionation by chromatography, re-crystallization and the like.

Next, the polymer thin film of the present invention will be described.

The polymer thin film of the present invention is characterized in that it contains the polymer compound of the present invention described above.

The thickness of the polymer thin film of the present invention is usually about 1 nm to 100 μm, preferably 2 nm to 1000 nm, further preferably 5 nm to 500 nm, particularly preferably 20 nm to 200 nm.

The polymer thin film of the present invention may be that containing one of the above-described polymer compounds singly or may be that containing two or more of the above-described polymer compounds. For enhancing electron transportability or hole transportability of the polymer thin film, a low molecular weight compound or polymer compound having electron transportability or hole transportability can also be mixed and used in addition to the above-described polymer compounds. As the hole transport material, known materials can be used, and exemplified are pyrazoline derivatives, arylamine derivatives, stilbene derivatives, triphenyldiamine derivatives, oligo thiophene or its derivatives, polyvinylcarbazole or its derivatives, polysilane or its derivatives, polysiloxane derivatives having an aromatic amine in the side chain or main chain, polyaniline or its derivatives, polythiophene or its derivatives, polypyrrole or its derivatives, polyphenylenevinylene or its derivatives, polythienylenevinylene or its derivatives, and the like, and as the electron transport material, known materials can be used, and exemplified are oxadiazole derivatives, anthraquinodimethane or its derivatives, benzoquinone or its derivatives, naphthoquinone or its derivatives, anthraquinone or its derivatives, tetracyanoanthraquinodimethane or its derivatives, fluorenone derivatives, diphenyldicyanoethylene or its derivatives, diphenoquinone derivatives, metal complexes of 8-hydroxyquinoline or its derivatives, polyquinoline or its derivatives, polyquinoxaline or its derivatives, polyfluorene or its derivatives, and the like.

The polymer thin film of the present invention may contain a charge generating material for generating charge by a light absorbed in the polymer thin film. As the charge generating material, known materials can be used, and exemplified are azo compounds and derivatives thereof, diazo compounds and derivatives thereof, non-metal phthalocyanine compounds and derivatives thereof, metal phthalocyanine compounds and derivatives thereof, perylene compounds and derivatives thereof, polycyclic quinine-based compounds and derivatives thereof, squalilium compounds and derivatives thereof, azulenium compounds and derivatives thereof, thiapyrylium compounds and derivatives thereof, fullerenes such as C60 and the like and derivatives thereof.

Further, the polymer thin film of the present invention may contain materials necessary for manifesting various functions. For example, sensitizers for sensitizing a function for generating charge by a light absorbed, stabilizers for increasing stability, UV absorbers for absorbing UV light, and the like are exemplified.

The polymer thin film of the present invention may also contain as a polymer binder a polymer compound material other than the above-described polymer compounds, for enhancing a mechanical property. As the polymer binder, those not extremely inhibiting electron transportability or hole transportability are preferable, and those not showing strong absorption for visible light are preferably used. Exemplified as the polymer binder are poly(N-vinylcarbazole), polyaniline or its derivatives, polythiophene or its derivatives, poly(p-phenylenevinylene) or its derivatives, poly(2,5-thienylenevinylene) or its derivatives, polycarbonate, polyacrylate, polymethyl acrylate, polymethyl methacrylate, polystyrene, polyvinyl chloride, polysiloxane and the like.

The method for producing the polymer thin film of the present invention is not particularly restricted, and exemplified are methods in which a film is formed from a solution containing the above-described polymer compound, and an electron transportable material or hole transportable material and a polymer binder to be mixed if necessary.

The solvent to be used for film formation from a solution is not particularly restricted providing it dissolves the above-described polymer compound, and an electron transportable material or hole transportable material and a polymer binder to be mixed.

As the solvent to be used in the case of formation of the polymer thin film of the present invention from a solution, exemplified are unsaturated hydrocarbon-based solvents such as toluene, xylene, mesitylene, tetralin, decalin, n-butylbenzene and the like, halogenated saturated hydrocarbon-based solvents such as carbon tetrachloride, chloroform, dichloromethane, dichloroethane, chlorobutane, bromobutane, chloropentane, bromopentane, chlorohexane, bromohexane, chlorocyclohexane, bromocyclohexane and the like, halogenated unsaturated hydrocarbon-based solvents such as chlorobenzene, dichlorobenzene, trichlorobenzene and the like, ether-based solvents such as tetrahydrofuran, tetrahydropyran and the like. The polymer compound can be dissolved usually in an amount of 0.1 wt % or more in these solvents, depending on the structure and molecular weight of the polymer compound.

As the method for film formation from a solution, there can be used coating methods such as a spin coat method, casting method, micro gravure coat method, gravure coat method, bar coat method, roll coat method, wire bar coat method, dip coat method, spray coat method, screen printing method, flexographic printing method, offset printing method, inkjet printing method, dispenser printing method and the like, and a spin coat method, flexographic printing method, inkjet printing method and dispenser printing method are preferable.

The method for producing the polymer thin film of the present invention may contain a process of orienting a polymer compound.

The polymer thin film containing a polymer compound oriented by this process shows improvement in electron mobility or hole mobility since main chain molecules or side chain molecules align along one direction.

As the method for orienting a polymer compound, there can be used methods known as a liquid crystal orientation technology, for example, methods described in “ekisho no kiso to oyo” (Shoichi Matsumoto, Ichiyoshi Kadota collaboration, Kogyo Chosakai 1991), chapter 5, “kyoyudensei ekisho no kozo to bussei” (Atsuo Fukuda, Hideo Takezoe collaboration, Coronasha 1990), chapter 7, “ekisho” vol. 3, no. 1 (1999), p. 3 to 16, and the like. Of them, a rubbing method, photo-alignment method, shearing method (shear stress applying method) and lifting coating method are simple and useful as an orientation method and easily used, and a rubbing method and a shearing method are preferable.

The rubbing method is a method of slightly rubbing the surface of a substrate with cloth and the like. As the substrate, glass, polymer film and the like can be used. As the cloth for rubbing a substrate, there can be used gauze, polyester, cotton, nylon, rayon and the like. When an orientation film is separately formed on a substrate, an orientation ability increases further. Here, mentioned as the orientation film are polyimide, polyamide, PVA, polyester, nylon and the like, and commercially available orientation films for liquid crystal can also be used. The orientation film can be formed by a spin coat method, flexographic printing and the like. The clothe used for rubbing can be appropriately selected according to the orientation film to be used.

The photo-alignment method is a method in which an orientation film is formed on a substrate and irradiated with polarized UV light or with UV light at inclined incident angle, to impart an orientation function. As the orientation film, mentioned are polyimide, polyamide, polyvinyl cinnamate and the like, and commercially available orientation films for liquid crystal can also be used.

In the rubbing method or photo-alignment method, orientation can be attained by sandwiching an oriented polymer compound material between substrate subjected to the above-described treatment. In this case, it is necessary to set the substrate temperature at which the material is in liquid crystal phase or isotropic phase. The temperature may be set before sandwiching a polymer compound material between substrate, or after sandwiching. It is also permissible that the polymer compound material is only coated on a substrate subjected to the orientation treatment. Coating of a polymer compound can be conducted by methods in which a polymer compound is placed on a substrate and set at a temperature of Tg or higher or at which liquid crystal phase or isotropic phase is shown, and the polymer compound is coated toward one direction by a rod and the like, alternatively, a polymer compound is dissolved in an organic solvent to prepare a solution which is coated by spin coat, flexographic printing and the like.

The shearing method is a method in which on a polymer compound material placed on a substrate, another substrate is placed, and the upper substrate is shifted toward one direction under temperatures causing liquid crystal phase or isotropic phase. In this case, when substrate subjected to the orientation treatment as described in the above-described rubbing method and photo-alignment method are used, those of higher degree of orientation are obtained. As the substrate, glass, polymer film and the like can be used, and the subject to be shifted by stress may not be a substrate but a metal rod and the like.

The lifting coating method is a technology in which a substrate is immersed in a solution of a polymer compound, then, lifter. The organic solvent to be used in the polymer compound solution and the lifting speed are not particularly restricted, and can be selected and adjusted according to the degree of orientation of the polymer compound.

The process for orienting a polymer compound includes a case of performing after a process of rendering a polymer compound into a thin film such as a rubbing method, a shearing method and the like and a case of performing simultaneously with a process of rendering a polymer compound into a thin film such as a lifting coating method and the like. Alternatively, a process of manufacturing an orientation film may be contained before a process of rendering a polymer compound into a thin film.

Since the polymer thin film of the present invention has electron transportability or hole transportability, it can be used for various polymer thin film devices such as organic thin film transistors, organic solar batteries, optical sensors, electrophotography photoreseptors, spatial light modulators, photo-refractive devices and the like by controlling transportation of electrons or holes injected from an electrode or charges generated by light absorption. When the polymer thin film is used for these polymer thin film devices, it is preferable to orient the film by an orientation treatment before use since then electron transportability or hole transportability is further improved.

Application of the polymer thin film of the present invention to organic thin film transistors will be described.

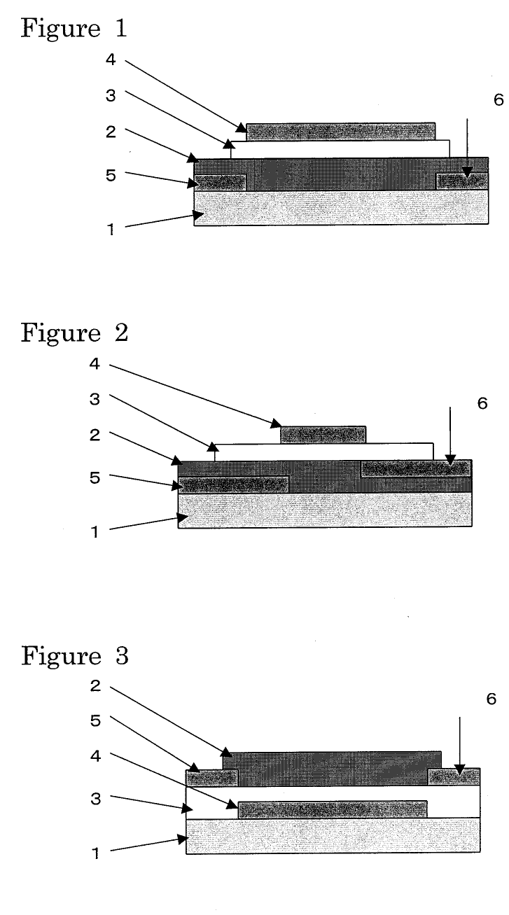

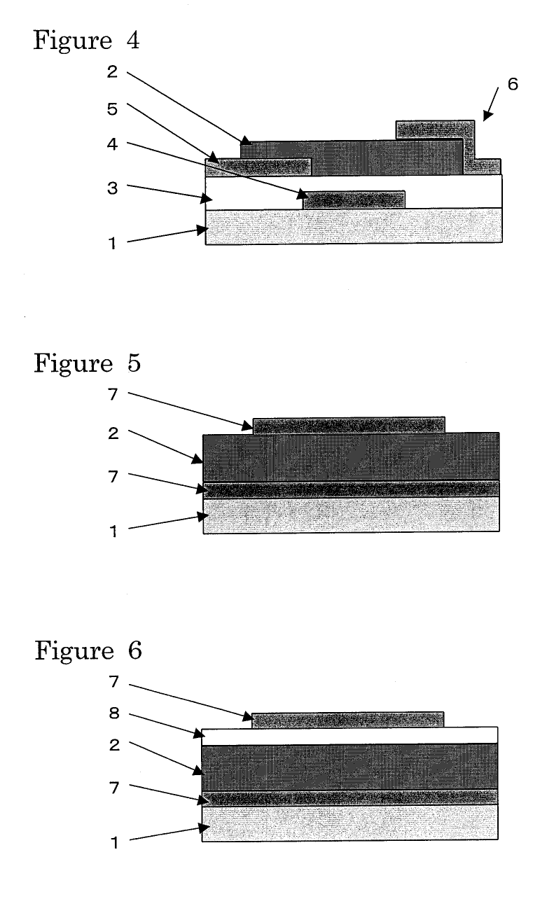

In the structure of the organic thin film transistor of the present invention, it is usual that a source electrode and a drain electrode are provided next to an active layer made of a polymer compound, further, a gate electrode is advantageously provided sandwiching an insulation layer next to the active layer, and structures in FIGS. 1 to 4 are exemplified.

The organic thin film transistor is formed usually on a supporting substrate. The material of the supporting substrate is not particularly restricted providing it does not disturb the property as the organic thin film transistor, and glass substrate and flexible film substrate and plastic substrate can also be used.

The organic thin film transistor can be produced by known methods, for example, a method described in JP-A No. 5-110069. Informing an active layer, use of a polymer compound soluble in an organic solvent is very advantageous and preferable from the standpoint of production, thus, a polymer thin film as an active layer can be formed using the method of producing the polymer thin film of the present invention described above.

The insulation layer next to the active layer is not particularly restricted providing it is a material of high electric insulation, and known materials can be used. For example, SiOx, SiNx, Ta₂O₅, polyimide, polyvinyl alcohol, polyvinylphenol and the like are mentioned. From the standpoint of lowering of voltage, materials of higher dielectric are preferable.

In the case of formation of an active layer on an insulation layer, it is also possible to effect surface modification by treating the surface of the insulation layer with a surface treating agent such as a silane coupling agent and the like, for improving an interface property between the insulation layer and the active layer, before formation of the active layer. As the surface treating agent, mentioned are long chain alkylchlorosilanes, long chain alkylalkoxysilanes, fluorinated alkylchlorosilanes, fluorinated alkylalkoxysilanes and the like. It is also possible to treat the surface of the insulation layer by ozone UV or O₂ plasma before treating with a surface treating agent.

Preferable is a sealed organic thin film transistor obtained by manufacturing an organic thin film transistor, then, insulating the manufactured transistor. By this, the organic thin film transistor is blocked from atmospheric air, and lowering of the property of the organic thin film transistor can be suppressed.

As the sealing method, mentioned are a method of covering with UV hardening resins, thermosetting resins, inorganic SiONx films and the like, a method of pasting glass substrates or films with UV hardening resins, thermosetting resins and the like. For effectively performing blocking from atmospheric air, it is preferable to carry out the process from manufacturing of an organic thin film transistor to sealing, without exposing to atmospheric air (for example, in dried nitrogen atmosphere, in vacuo and the like).

FIG. 5 is a view illustrating application of the polymer thin film of the present invention to a solar battery as a typical example. A structure is used in which a polymer thin film is placed between a pair of electrodes one of which is transparent or semi-transparent. As the electrode material, there can be used metals such as aluminum, gold, silver, copper, alkali metals, alkaline earth metals and the like, or semi-transparent films and transparent conductive films thereof. For obtaining higher open-circuit voltage, it is preferable that electrodes are selected so that a difference in work function is higher. For enhancing light sensitivity, a carrier generator, sensitizer and the like can be added and used in a polymer thin film. As the substrate material, a silicon substrate, glass substrate, plastic substrate and the like can be used.

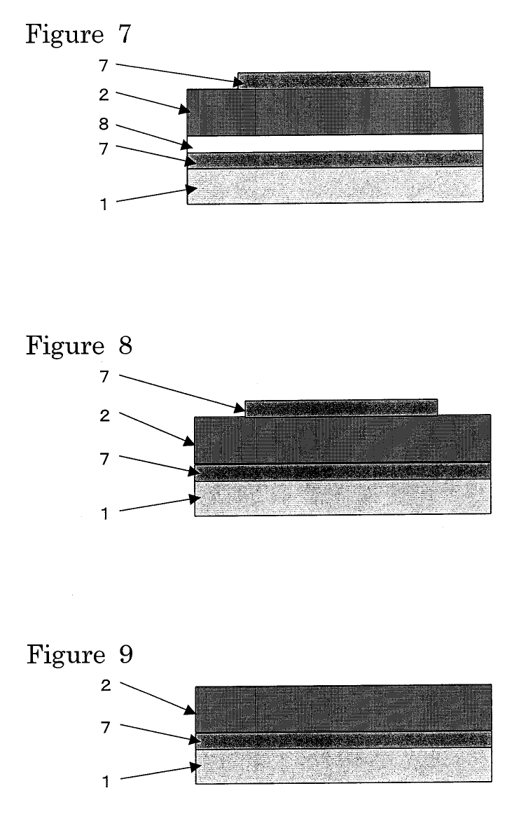

FIGS. 6 to 8 are views illustrating application of the polymer thin film of the present invention to an optical sensor as a typical example. A structure is used in which a polymer thin film is placed between a pair of electrodes one of which is transparent or semi-transparent. A charge generating layer which absorbs light and generates charge can also be inserted and used. As the electrode material, there can be used metals such as aluminum, gold, silver, copper, alkali metals, alkaline earth metals and the like, or semi-transparent films and transparent conductive films thereof. For enhancing light sensitivity, a carrier generator, sensitizer and the like can be added and used in a polymer thin film. As the substrate material, a silicon substrate, glass substrate, plastic substrate and the like can be used.

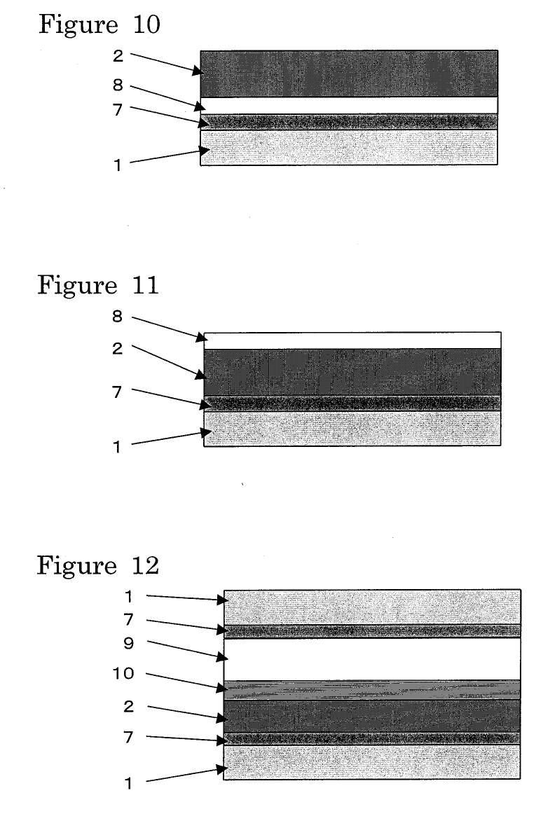

FIG. 9 to 11 are views illustrating application of the polymer thin film of the present invention to an electrophotographic photoreceptor as a typical example. A structure is used in which a polymer thin film is placed on an electrode. A charge generating layer which absorbs light and generates charge can also be inserted and used. As the electrode material, there can be used metals such as aluminum, gold, silver, copper and the like. For enhancing light sensitivity, a carrier generator, sensitizer and the like can be added and used in a polymer thin film. As the substrate material, a silicon substrate, glass substrate, plastic substrate and the like can be used, and it is also possible that a metal such as aluminum and the like is used as a substrate material and an electrode simultaneously.

FIG. 12 is a view illustrating application of the polymer thin film of the present invention to a spatial light modulator as a typical example. A structure is used in which a polymer thin film, dielectric layer mirror and liquid crystal layer are placed between a pair of transparent or semi-transparent electrodes. The dielectric layer mirror is preferably composed of a multi-layer film of dielectric, and design is so made that a wavelength region of low refractive index and a wavelength region of high refractive index are present and boundary thereof rises steeply. In the liquid crystal layer, various liquid crystal materials can be used, and ferroelectric liquid crystals are preferably used. As the electrode material, semiconductor films and transparent conductive films of aluminum, gold, silver, copper and the like showing high electric conductivity can be used. As the substrate material, transparent or semi-transparent materials such as glass substrates, plastic substrates and the like can be used.

Examples for illustrating the present invention further in detail will be shown below, but the present invention is not limited to them.

Here, regarding the number-average molecular weight, a polystyrene-reduced number-average molecular weight was measured by gel permeation chromatography (GPC) using chloroform as a solvent.

### REFERENCE SYNTHESIS EXAMPLE 1

Into a nitrogen-purged 500 ml three-necked flask was placed 6.65 g of 2,7-dibromo-9-fluorenone, and dissolved in 140 ml of a mixed solvent of trifluoroacetic acid:chloroform=1:1. To this solution was added sodium perborate mono-hydrate and the mixture was stirred for 20 hours. The reaction liquid was filtrated through cerite, and washed with toluene. The filtrate was washed with water, sodium hydrogen sulfite and saturated saline, then, dried over sodium sulfate. After distilling the solvent off, 6.11 g of a coarse product was obtained.

This coarse product was re-crystallized from toluene, further, re-crystallized from chloroform, to obtain 1.19 g of compound 1. 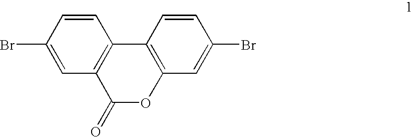
Preparation of C₈H₁₇MgBr

Into a 100 ml three-necked flask was placed 1.33 g of magnesium, and flame-dried and purged with argon. To this was added 10 ml of THF and 2.3 ml of 1-bromooctane, and the mixture was heated to initiate the reaction. After refluxing for 2.5 hours, the reaction liquid was allowed to cool to room temperature.

Grignard Reaction

Into a nitrogen-purged 300 ml three-necked flask was placed 1.00 g of compound 1, and suspended in 10 ml of THF. The suspension was cooled down to 0° C., and the C₈H₁₇MgBr solution prepared above was added. A cooling bath was taken away, and the reaction liquid was stirred for 5 hours under reflux. The reaction liquid was allowed to cool, and 10 ml of water and hydrochloric acid were added. The liquid was suspension before adding hydrochloric acid, however, it was converted into a two-phase solution after addition. After liquid separation, the organic phase was washed with water and saturated saline. This phase was dried over sodium sulfate, and the solvent was distilled off, to obtain 1.65 g of a coarse product. The coarse product was purified by silica gel column chromatography (hexane:ethyl acetate=20:1), to obtain 1.30 g of compound 2.

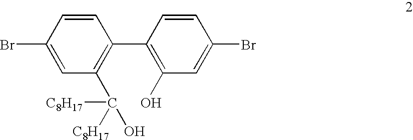

Into a nitrogen-purged 25 ml two-necked flask was placed 0.20 g of compound 2, and dissolved in 4 ml of toluene. To this solution was added 0.02 g (0.06 mmol) of p-toluenesulfonic acid mono-hydrate, and the mixture was stirred for 11 hours at 100° C. The reaction liquid was allowed to cool, then, washed with water, 4N NaOH aqueous solution, water and saturated saline in this order, and the solvent was distilled off to obtain 0.14 g of compound 3

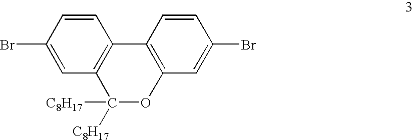

Under a nitrogen atmosphere, into a reaction vessel was added 1.0 g (1.77 mmol) of the above-described compound 3, 0.945 g (3.72 mmol) of bis(pinacolate)diborone, 0.078 g (0.11 mmol) of [1,1′-bis(diphenylphosphino)ferrocene]palladium dichloride, 0.059 g (0.11 mmol) of 1,1′-bis(diphenylphosphino)ferrocene and 15 ml of 1,4-dioxane, and an argon gas was bubbled into this mixture for 30 minutes. Thereafter, 1.043 g (10.6 mmol) of potassium acetate was added, and reacted under a nitrogen atmosphere at 95° C. for 13.5 hours. After completion of the reaction, the reaction liquid was filtrated to removed insoluble substances. The product was purified by an alumina short column, the solvent was distilled off, then, the residue was dissolved in toluene, and activated carbon was added and the mixture was stirred, and filtrated. The filtrate was purified again by an alumina short column, and activated carbon was added and the mixture was stirred, and filtrated. Toluene was removed completely, then, 2.5 ml of hexane was added and re-crystallization was performed, to obtain 0.28 g of compound 3-a described below.

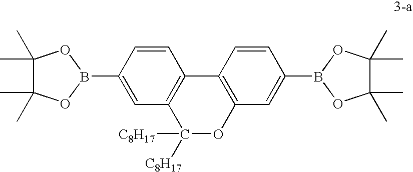

### REFERENCE SYNTHESIS EXAMPLE 2

Compound 4 shown below was obtained by a method described in JP-A No. 2004-043544.

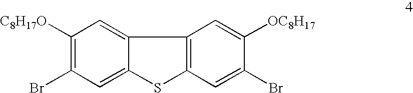

Using the above-described compound 4, compound 4-a shown below was obtained by the same manner as in Reference Synthesis

### EXAMPLE 1

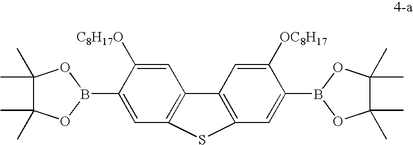

### EXAMPLE 1

### Synthesis of Polymer Compound A

0.62 g of the above-described compound 3-a, 0.29 g of 5,5′-dibromo-2,2′-bithiophene and 0.36 g of Aliquat 336 (manufactured by ACROS ORGANICS) were charged in a reaction vessel. Afterward, operations were carried out under a nitrogen atmosphere until a reaction. Into the above-described reaction vessel was added 9.3 g of toluene deaerated previously by bubbling with an argon gas. Then, into this mixed solution was added a solution prepared by dissolving 0.39 g of potassium carbonate in 9.6 g of ion exchange water deaerated previously by bubbling with an argon gas. Subsequently, 2.1 mg of tetrakis(triphenylphosphine)palladium(0). The reactions were all conducted under a nitrogen atmosphere. The mixture was reacted under reflux conditions for 16.3 hours, then, 18.4 mg of bromobenzene was added, and the mixture was reacted under reflux conditions for 2 hours. Further, 19.0 mg of 2-phenyl-1,3,2-dioxabolinane was added, and the mixture was reacted under reflux conditions for 2 hours. After the reaction, this two-phase solution was cooled, and the aqueous layer was removed. Since the organic solvent layer was very viscous, chloroform was added for dilution. This mixed solution was poured into methanol and the mixture was stirred for about 1 hour. Then, the produced precipitate was recovered by filtration. This precipitate was dried under reduce pressure, then, dissolved in chloroform. This solution was purified by passing through a column filled with silica and alumina. Then, this solution was poured into methanol to cause re-precipitation, and the produced precipitate was recovered.

This precipitate was dried under reduced pressure to obtain 0.53 g of polymer compound A.

This polymer compound A has a polystyrene-reduced number-average molecular weight of 1.2×10⁶.

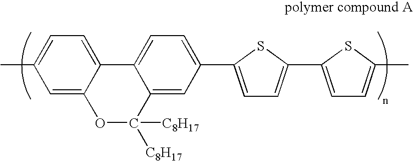

### EXAMPLE 2

### Synthesis of Polymer Compound B

0.73 g of the above-described compound 4-a, 0.32 g of 5,5′-dibromo-2,2′-bithiophene and 0.40 g of Aliquat 336 were charged in a reaction vessel. Afterward, operations were carried out under a nitrogen atmosphere until a reaction. Into the above-described reaction vessel was added 10.4 g of toluene deaerated previously by bubbling with an argon gas. Then, into this mixed solution was added a solution prepared by dissolving 0.44 g of potassium carbonate in 10.7 g of ion exchange water deaerated previously by bubbling with an argon gas. Subsequently, 2.3 mg of tetrakis(triphenylphosphine)palladium(0). The reactions were all conducted under a nitrogen atmosphere. The mixture was reacted under reflux conditions for 15 hours, then, 20.4 mg of bromobenzene was added, and the mixture was reacted under reflux conditions for 2 hours. Further, 21.1 mg of 2-phenyl-1,3,2-dioxabolinane was added, and the mixture was reacted under reflux conditions for 2 hours. After the reaction, this two-phase solution was cooled, and the organic solvent layer was poured into methanol and the mixture was stirred for about 1 hour. Then, the produced precipitate was recovered by filtration. This precipitate was dried under reduce pressure, then, dissolved in chloroform. This solution was purified by passing through a column filled with silica and alumina. Then, this solution was poured into methanol to cause re-precipitation, and the produced precipitate was recovered.

This precipitate was dried under reduced pressure to obtain 0.56 g of polymer compound B.

This polymer compound B had a polystyrene-reduced number-average molecular weight of 3.9×10⁵.

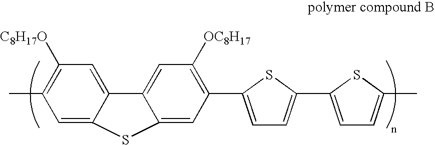

### EXAMPLE 3

### Manufacturing of Polymer Thin Film Device and Evaluation of Organic Thin Film Transistor Property

An n-type silicon substrate doped at high concentration as a gate electrode having a surface on which 200 nm of a silicon oxide as an insulation layer had been formed by thermal oxidation was purchased, and washed with an alkali detergent, ultrapure water and acetone under ultrasonic wave, then, the surface was washed by irradiation with ozone UV. The substrate was immersed in a 5 mM octane solution of octadecyltrichlorosilane for 12 hours in a nitrogen atmosphere to perform silane treatment of the surface of the silicon substrate, thereafter, the substrate was rinsed with octane and chloroform in this order. 0.018 g of polymer compound A was weighed, and chloroform was added to obtain a weight of 5.3 g, and the mixture was filtrated through a 3 μm film filter, then, using this coating liquid, a polymer thin film having a thickness of 70 nm containing polymer compound A was formed by a spin coat method on the above-described surface-treated substrate. On the polymer thin film, an Au electrode was vapor-deposited by a vacuum vapor deposition method, to form a source electrode and a drain electrode having a channel width of 2 mm and a channel length of 20 μm, manufacturing polymer thin film device 1.

On the manufactured polymer thin film device 1, gate voltage V_{G} was applied varying from 0 to −80V and source-drain voltage V_{SD} was applied varying from 0 to −80V in a nitrogen atmosphere and the organic thin film transistor property was measured to find an excellent Isd-Vg property, and the drain current was −1.4 μA at V_{g}=−80V and V_{sd}=−80V. The electron field effect mobility obtained from the Isd-Vg property was 1×10⁻³ cm²/Vs, and the current on/off ratio was 1×10⁶.

### REFERENCE SYNTHESIS EXAMPLE 3

### Synthesis of Polymer Compound C

0.96 g of the above-described compound 3 and 0.55 g of 2,2′-bipyridyl were charged in a reaction vessel, then, an atmosphere in the reaction system was purged with a nitrogen gas. To this was added 80 g of tetrahydrofuran (THF) (dehydrated solvent) deaerated previously by bubbling with an argon gas. Next, to this mixed solution was added 1.05 g of bis(1,5-cyclooctadiene)nickel(0) {Ni(COD)2}, and the mixture was stirred at room temperature for 10 minutes, then, reacted at 60° C. for 1.5 hours. The reaction was carried out in a nitrogen gas atmosphere. After the reaction, this solution was cooled, then, poured into a methanol 100 ml/ion exchange water 200 ml mixed solution, and the mixture was stirred for about 1 hour. Then, the produced precipitate was recovered by filtration. This precipitate was dried under reduced pressure, then, dissolved in chloroform. This solution was filtrated to remove insoluble substances, then, this solution was purified by passing through a column filled with alumina. Then, this solution was poured into methanol to cause re-precipitation, and the produced precipitate was recovered. This precipitate was dried under reduced pressure, to obtain 0.5 g of polymer compound C.

This polymer compound C had a polystyrene-reduced number-average molecular weight of 7.3×10⁵.

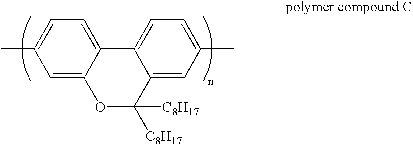

### COMPARATIVE EXAMPLE 1

### Manufacturing of Polymer Thin Film Device and Evaluation of Organic Thin Film Transistor Property

A polymer thin film having a thickness of 50 nm containing polymer compound C was formed by a spin coat method on the above-described surface-treated substrate, by the same manner as in Example 3 excepting polymer compound C was used instead of polymer compound A. On the polymer thin film, an Au electrode was vapor-deposited by a vacuum vapor deposition method, to form a source electrode and a drain electrode having a channel width of 2 mm and a channel length of 20 μm, manufacturing polymer thin film device 2.

On the manufactured polymer thin film device 2, gate voltage V_{G} was applied varying from 0 to −80V and source-drain voltage V_{SD} was applied varying from 0 to −80V in a nitrogen atmosphere and the organic thin film transistor property was measured. The drain current was as low level as −0.8 μA at V_{g}=−80V and V_{sd}=−60V.

### EXAMPLE 4

### Manufacturing of Polymer Thin Film Device and Evaluation of Solar Battery Property

On a glass substrate carrying an ITO film having a thickness of 150 nm formed by a sputtering method, a suspension of poly(3,4)ethylenedioxythiophene/polystyrenesulfonic acid (manufactured by Bayer, Baytron PAI 4083) was filtrated through a 0.2 μm membran filter, then, a thin film was formed having a thickness of 70 nm by spin coat, and dried on a hot plate at 200° C. for 10 minutes. Then, a polymer thin film was formed having a thickness of 50 nm by spin coat at room temperature using a 0.2 wt % chloroform solution of polymer compound A. Further, this was dried under reduced pressure at 60° C. for 1 hour, then, lithium fluoride was vapor-deposited at a thickness of about 0.4 nm, then, calcium was vapor-deposited at a thickness of 5 nm, further, aluminum was vapor-deposited at a thickness of 180 nm as electrodes, manufacturing polymer thin film device 3 using polymer compound A. The degrees of vacuum in vapor deposition were all 1×10⁻⁴ Pa or less. While irradiating the resultant polymer thin film device 3 by a xenon lamp, the voltage-current property was measured, obtaining solar battery properties of a short-circuit current of 43 μA/cm² and a open-circuit voltage of 1.75 V.

### EXAMPLE 5

### Manufacturing of Polymer Thin Film Device and Evaluation of Solar Battery Property

Polymer thin film device 4 was manufactured by the same manner as in Example 5 using polymer compound B instead of polymer compound A. While irradiating the resultant polymer thin film device 4 by a xenon lamp, the voltage-current property was measured, obtaining a short-circuit current of 38 μA/cm² and a open-circuit voltage of 1.15 V.

### EXAMPLE 6

### Synthesis of Polymer Compound D

1.13 g of the above-described compound 3-a, 0.60 g of 1,2-di(5-dibromo-2-thienyl)ethene (synthesis method is described in, for example, M. Fuji et at., Synthetic Metals, 55-57, 2136-2139 (1993)) and 0.69 g of Aliquat 336 were charged in a reaction vessel. Afterward, operations were carried out under a nitrogen atmosphere until a reaction. Into the above-described reaction vessel was added 19.4 g of toluene deaerated previously by bubbling with an argon gas. Then, into this mixed solution was added a solution prepared by dissolving 0.74 g of potassium carbonate in 20.0 g of ion exchange water deaerated previously by bubbling with an argon gas. Subsequently, 3.9 mg of tetrakis(triphenylphosphine)palladium(0). The reactions were all conducted under a nitrogen atmosphere. The mixture was reacted under reflux conditions for 15 hours, then, 34.7 mg of bromobenzene was added, and the mixture was reacted under reflux conditions for 2 hours. Further, 35.8 mg of 2-phenyl-1,3,2-dioxabolinane was added, and the mixture was reacted under reflux conditions for 2 hours. After the reaction, this two-phase solution was cooled, and the organic solvent layer was poured into methanol and the mixture was stirred for about 1 hour. Then, the produced precipitate was recovered by filtration.

This precipitate was dried under reduce pressure, to obtain 1.00 g of polymer compound D. This polymer compound D has a polystyrene-reduced number-average molecular weight of 1×10⁶ or more.

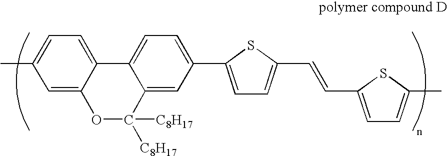

### EXAMPLE 7

### Manufacturing of Polymer Thin Film Device and Evaluation of Organic Thin Film Transistor Property

0.008 g of polymer compound D was weighed, and dichlorobenzene was added to obtain a weight of 2 g, preparing coating liquid. An n-type silicon substrate doped at high concentration as a gate electrode having a surface on which 200 nm of a silicon oxide as an insulation layer had been formed by thermal oxidation was purchased, and washed with an alkali detergent, ultrapure water and acetone under ultrasonic wave, then, the surface was washed by irradiation with ozone UV. On the substrate, an Au electrode was vapor-deposited by a vacuum vapor deposition method, to form a source electrode and a drain electrode having a channel width of 2 mm and a channel length of 20 μm. The substrate with electrodes was set on a spin coater, and Hexamethyldisilazane (HMDS) manufactured by Aldrich was dropped, then, spun at 2000 rpm, and the surface of the substrate was treated with HMDS. Using the above-described coating liquid of polymer compound D, the polymer compound D was coated so as to cover a portion between the source electrode and the drain electrode using a needle tip having an internal diameter of 100 μm by a dispenser printing method (manufactured by Musashi Engineering, Shot Mini), to form a thin film having a thickness of 700 nm. Then, the film was baked at 120° C. for 30 minutes in a nitrogen atmosphere, to manufacture polymer thin film device 5.

On the manufactured polymer thin film device 5, gate voltage V_{G} was applied varying from 0 to −60V and source-drain voltage V_{SD} was applied varying from 0 to −60V in vacuum and the organic thin film transistor property was measured to find an excellent Isd-Vg property, and the drain current was −0.6 μA at V_{g}=−60V and V_{sd}=−60V. The electron field effect mobility obtained from the Isd-Vg property was 5×10⁻⁴ cm²/Vs, and the current on/off ratio was 1×10³.

### INDUSTRIAL APPLICABILITY

The polymer compound of the present invention is useful as a material of a thin film for a polymer thin film device.

1. A polymer compound comprising a repeating unit of the following formula (1) and a repeating unit of the following formula (2) and having a polystyrene-reduced number-average molecular weight of 10³ to 10⁸: 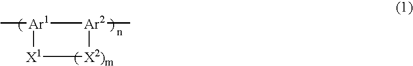
(wherein, Ar¹ and Ar² represent each independently a tri-valent aromatic hydrocarbon group or a tri-valent heterocyclic group, X¹ and X² represent each independently O, S, C(═O), S(═O), SO₂, C(R¹)(R²), Si(R³)(R⁴), N(R⁵), B(R⁶), P(R⁷) or P(═O) (R⁸), R¹ to R⁸ represent each independently a hydrogen atom, halogen atom, alkyl group, alkyloxy group, alkylthio group, aryl group, aryloxy group, arylthio group, arylalkyl group, arylalkyloxy group, arylalkylthio group, acyl group, acyloxy group, amide group, acid imide group, imine residue, amino group, substituted amino group, substituted silyl group, substituted silyloxy group, substituted silylthio group, substituted silylamino group, mono-valent heterocyclic group, heteroaryloxy group, heteroarylthio group, arylalkenyl group, arylethynyl group, carboxyl group, alkyloxycarbonyl group, aryloxycarbonyl group, arylalkyloxycarbonyl group, heteroaryloxycarbonyl group or cyano group. Here, X¹ and X² are not identical. R¹ and R² in C(R¹)(R²) and R³ and R⁴ in Si(R³)(R⁴) may mutually be connected to form a ring. m represents 0 or 1, and n represents an integer from 1 to 6. When m=0, X¹ does not represent C(R¹)(R²). X¹ and Ar² are connected to adjacent positions of the aromatic ring of Ar¹, and when m=1, X² and Ar¹ are connected to adjacent positions of the aromatic ring of Ar², when m=0, X¹ and Ar¹ are connected to adjacent positions of the aromatic ring of Ar².), 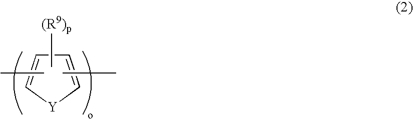
(wherein, o represents an integer from 1 to 10, p represents an integer from 0 to 2, Y represents O, S, C(R¹⁰)(R¹¹), Si(R¹²)(R¹³) or N(R¹⁴), and when a plurality of Ys are present, they may be the same or different, and R¹⁰, R¹¹, R¹², R¹³ and R¹⁴ represent each independently a hydrogen atom, halogen atom, alkyl group, alkyloxy group, alkylthio group, aryl group, aryloxy group, arylthio group, arylalkyl group, arylalkyloxy group, arylalkylthio group, acyl group, acyloxy group, amide group, acid imide group, imine residue, amino group, substituted amino group, substituted silyl group, substituted silyloxy group, substituted silylthio group, substituted silylamino group, mono-valent heterocyclic group, heteroaryloxy group, heteroarylthio group, arylalkenyl group, arylethynyl group, carboxyl group, alkyloxycarbonyl group, aryloxycarbonyl group, arylalkyloxycarbonyl group, heteroaryloxycarbonyl group or cyano group, here, R¹⁰ and R¹¹, and R¹² and R¹³ may mutually be connected to form a ring, and R⁹ represents a halogen atom, alkyl group, alkyloxy group, alkylthio group, aryl group, aryloxy group, arylthio group, arylalkyl group, arylalkyloxy group, arylalkylthio group, acyl group, acyloxy group, amide group, acid imide group, imine residue, amino group, substituted amino group, substituted silyl group, substituted silyloxy group, substituted silylthio group, substituted silylamino group, mono-valent heterocyclic group, heteroaryloxy group, heteroarylthio group, arylalkenyl group, arylethynyl group, carboxyl group, alkyloxycarbonyl group, aryloxycarbonyl group, arylalkyloxycarbonyl group, heteroaryloxycarbonyl group or cyano group. When a plurality of R^{9s} are present, they may be the same or different, and R^{9s} may be mutually connected to form a ring.).

2. The polymer compound according to claim 1, comprising a repeating unit of the above-described formula (1), a repeating unit of the above-described formula (2) and a repeating unit of the following formula (3) and having a polystyrene-reduced number-average molecular weight of 10³ to 10⁸: 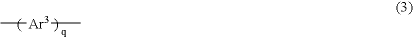
(wherein, Ar³ represents a di-valent aromatic hydrocarbon group, a di-valent heterocyclic group or —CR¹⁵═CR¹⁶—. R¹⁵ and R¹⁶ represent each independently a hydrogen atom, halogen atom, alkyl group, alkyloxy group, alkylthio group, aryl group, aryloxy group, arylthio group, arylalkyl group, arylalkyloxy group, arylalkylthio group, acyl group, acyloxy group, amide group, acid imide group, imine residue, amino group, substituted amino group, substituted silyl group, substituted silyloxy group, substituted silylthio group, substituted silylamino group, mono-valent heterocyclic group, heteroaryloxy group, heteroarylthio group, arylalkenyl group, arylethynyl group, carboxyl group, alkyloxycarbonyl group, aryloxycarbonyl group, arylalkyloxycarbonyl group, heteroaryloxycarbonyl group or cyano group. q represents an integer from 1 to 6.).

3. The polymer compound according to claim 1, wherein X¹ in the formula (1) is O, S, C(O), S(O) or SO₂.

4. The polymer compound according to claim 1, wherein X² in the formula (1) is C(R¹)(R²), Si(R³)(R⁴, N(R⁵), B(R⁶), P(R⁷) or P(═O) (R⁸) (wherein, R¹ to R⁸ represent each independently the same meanings as described above).

5. The polymer compound according to claim 1, wherein Ar¹ and Ar² in the formula (1) represent each independently a tri-valent aromatic hydrocarbon group.

6. The polymer compound according to claim 1, wherein Y in the formula (2) is S.

7. The polymer compound according to claim 2, wherein Ar³ in the formula (3) is —CR¹⁵═CR¹⁶— (wherein, R¹⁵ and R¹⁶ represent the same meanings as described above).

8. The polymer compound according to claim 1, wherein the sum of repeating units of the formulae (1) and (2) is 10 mol % or more based on all repeating units.

9. The polymer compound according to claim 1, having liquid crystallinity.

10. A polymer thin film comprising the polymer compound according to claim 1 and having a film thickness of 1 nm to 100 μm.

11. A method of producing the polymer thin film according to claim 10, using a spin coat method, inkjet printing method, dispenser printing method or flexographic printing method.

12. A method of producing the polymer thin film according to claim 10, comprising a process of orienting a polymer by a rubbing method or shearing method.

13. A polymer thin film device, comprising the polymer thin film according to claim 10.

14. An organic thin film transistor, comprising the polymer thin film according to claim 10.

15. An organic solar battery, comprising the polymer thin film according to claim 10.

16. An optical sensor, comprising the polymer thin film according to claim 10.

17. An electrophotographic photoreceptor, comprising the polymer thin film according to claim 10.

18. A spatial light modulator, comprising the polymer thin film according to claim 10.
